(19) United States
(12) Patent Application Publication
(10) Pub. No.: US 2025/0291111 A1
(43) Pub. Date: Sep. 18, 2025

(54) HYBRID INTEGRATION METHODS, DEVICES, AND SYSTEMS EXPLOITING ACTIVE-PASSIVE PHOTONIC ELEMENTS

(71) Applicant: AEPONYX INC., MONTREAL (CA)

(72) Inventors: JEROME LAPOINTE, QUEBEC CITY (CA); CEDRIK COIA, GREENFIELD PARK (CA); PHILIPPE BABIN, SHERBROOKE (CA); DAMIEN MICHEL, BROMONT (CA); REAL VALLEE, QUEBEC CITY (CA); MARTIN BERARD, TE-CATHERNINE-DE-LA-JACQUES CARTIER (CA); ANDRE FEKECS, SHERBROOKE (CA)

(21) Appl. No.: 18/858,889

(22) PCT Filed: Mar. 3, 2023
(86) PCT No.: PCT/CA2023/050273

§ 371 Date: Oct. 22, 2024

Related U.S. Application Data
(60) Provisional application No. 63/363,730, filed on Apr. 28, 2022.

(51) Int. Cl. G02B 6/13; B33Y 10/00; B33Y 80/00; C03B 19/01

(52) U.S. Cl. CPC G02B 6/13; B33Y 10/00; B33Y 80/00; C03B 19/01

(57) ABSTRACT

Different technologies, such as silicon photonics, offer promise for adding integrated optics functionality to integrated circuits by leveraging the economies of scale of the CMOS microelectronics industry. However, each technology has limitations. The inventors present hybrid integration methodologies, structures and techniques to integrate one or more active photonic components discretely or in combination with one or more other active photonic elements and/or passive photonic components exploiting, for example, optical waveguides and/or micro-optical elements and/or photonic wire bonds. Further, through direct laser writing the inventors have established magnetless Faraday rotator optical waveguides to add isolator, switch and circulator functionality for active photonic component integration via other active photonic elements and/or passive photonic components through optical waveguides, micro-optical elements and/or photonic wire bonds.

### CROSS-REFERENCE TO RELATED APPLICATIONS

This patent application claims the benefit of priority as a 371 national phase entry application of PCT/CA2023/050273 filed Mar. 3, 2023; which itself claims the benefit of priority to U.S. Provisional Patent Application 63/363,730 filed 28 Apr. 2022; the entire contents of each being incorporated herein by reference.

### FIELD OF THE INVENTION

invention is directed to photonic components and more particularly to establishing methods, devices and systems exploiting hybrid integration methodologies, structures and techniques integrating active photonic components discretely or in combination with other active photonic elements and/or passive photonic components exploiting micro-optical elements and/or photonic wire bonds discretely or in combination with providing optical elements for integration with waveguide structures that are directly written or patterned.

### BACKGROUND OF THE INVENTION

Photonics has become a dominant or evolving technological solution in a wide range of applications from sensing, biomedical sensing, to quantum computing, quantum sensing, and telecommunications. Transmitting optical signals over either short or long distances can place stringent constraints to maintain signal sensitivity wherein optical interconnectivity losses at every interface, component, system, or sub-system within the optical path should be minimized. In contrast, other applications require highly cost-effective solutions using correspondingly cost-effective and energy efficient devices which exploit low power transceivers but similarly require low loss optical interconnections.

Whilst different technologies, such as silicon photonics, have shown themselves to be a promising technology for adding integrated optics functionality to integrated circuits by leveraging the economies of scale of the CMOS microelectronics industry each technology has limitations with respect to the optical functionality achievable, optical operating wavelength range, optical loss, processing speed etc. Accordingly, it would be beneficial to provide optical component designers and manufacturers with one or more methods, devices and systems exploiting hybrid integration methodologies, structures and techniques to integrate one or more active photonic components discretely or in combination with one or more other active photonic elements and/or passive photonic components exploiting, for example, micro-optical elements and/or photonic wire bonds.

Accordingly, the inventors have established hybrid integration methodologies, structures and techniques integrating active photonic components discretely or in combination with other active photonic elements and/or passive photonic components exploiting micro-optical elements and/or photonic wire bonds.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations in the prior art relating to photonic components and more particularly to establishing methods, devices and systems exploiting hybrid integration methodologies, structures and techniques integrating active photonic components discretely or in combination with other active photonic elements and/or passive photonic components exploiting micro-optical elements and/or photonic wire bonds discretely or in combination with providing optical elements for integration with waveguide structures that are directly written or patterned.

In accordance with an embodiment of the invention there is provided a method forming an optical waveguide within a material comprising:
establishing a spatial profile for a focal region of an irradiating source through a volume of a material from a first side of the material to a second distal side of the material; and
executing a motion sequence such that the focal region the irradiating source traverses the spatial profile within the volume of the material; wherein
the optical waveguide is formed through the volume of the material from the first side of the material to the second distal side of the material.

In accordance with an embodiment of the invention there is provided a method comprising: providing an optical component; and
performing one or more direct write processing steps upon one or more portions of the optical component; wherein
each direct write processing step of the one or more direct write processing steps is selected from the group comprising etching, inducing damage to adjust a refractive index, doping, selectively depositing a material, triggering a phase change in another material, and triggering a chemical process within one or more further materials.

In accordance with an embodiment of the invention there is provided a method comprising:
providing an optical component;
providing a photonic integrated circuit (PIC) comprising:
an input waveguide coupled to a first end of the optical component for at least one of coupling optical signals to or receiving optical signals from the optical component;
an output waveguide coupled to a second distal end of the optical component for at least one of coupling optical signals to or receiving optical signals from the optical component;
assembling the optical component upon a first carrier; and
assembling the PIC upon a second carrier; wherein
the first carrier is either a substrate of the PIC or an intermediate carrier between the optical component and the second carrier;
a first portion of the optical component provides a passive optical function;
a second portion of the optical component provides an active optical function; and
the optical component is at least one of a thin film structure or a bulk structure.

In accordance with an embodiment of the invention there is provided a method comprising:
providing an optical component;
providing a photonic integrated circuit (PIC) comprising:
an input waveguide coupled to a first end of the optical component for at least one of coupling optical signals to or receiving optical signals from the optical component;
an output waveguide coupled to a second distal end of the optical component for at least one of coupling optical signals to or receiving optical signals from the optical component;
assembling the optical component upon a first carrier;
assembling the PIC upon a second carrier;
forming a first photonic wire bond (PWB) disposed between the optical component and the input waveguide;
forming a second PWB disposed between the optical component and the output waveguide; wherein
the first carrier is either a substrate of the PIC or an intermediate carrier between the optical component and the second carrier;
a first portion of the optical component provides a passive optical function;
a second portion of the optical component provides an active optical function; and
the optical component is at least one of a thin film structure or a bulk structure.

In accordance with an embodiment of the invention there is provided a method comprising:
providing an optical component;
providing a photonic integrated circuit (PIC) comprising an input waveguide coupled to a first end of the optical component for at least one of coupling optical signals to or receiving optical signals from the optical component;
assembling the optical component upon a first carrier;
assembling the PIC upon a second carrier;
forming a first photonic wire bond (PWB) disposed between the optical component and the input waveguide;
the first carrier is either a substrate of the PIC or an intermediate carrier between the optical component and the second carrier; wherein
a first portion of the optical component provides a passive optical function;
a second portion of the optical component provides an active optical function; and
the optical component is at least one of a thin film structure or a bulk structure.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1A depicts a schematic of a mechanical structure for the formation of a photonic wire bond (PWB) between an optical fiber within a U- or V-groove formed within a silicon substrate and an optical waveguide formed upon the silicon substrate according to an embodiment of the invention;

FIG. 1B depicts a schematic of a mechanical structure for the formation of a photonic wire bond (PWB) between a graded index optical fiber within a U- or V-groove formed within a silicon substrate and an optical waveguide formed upon the silicon substrate according to an embodiment of the invention wherein the graded index optical fiber is coupled to another optical element;

FIG. 1C depicts a schematic of a mechanical structure for the formation of a photonic wire bond (PWB) between an optical waveguide formed upon a silicon substrate according to an embodiment of the invention and another optical element;

FIG. 2A depicts a schematic of a multi-stage PWB formed with air-clad and non-air clad regions with common core material;

FIG. 2B depicts a schematic of a multi-stage PWB formed with different core materials;

FIG. 2C depicts a scanning electron micrograph of PWB interconnections between a pair of optical fibers and a pair of optical waveguides according to an embodiment of the invention;

FIG. 3 depicts thin film passive optical components employing intermediate support die (ISD) according to embodiments of the invention;

FIG. 4 depicts an active optical component integration employing an intermediate support die (ISD) according to an embodiment of the invention;

FIG. 5A depicts the integration of an ISD die with a thin film active element according to the design of FIG. 4 within an integrated photonics silicon chip (IPSC) according to an embodiment of the invention;

FIG. 5B depicts the integration of an ISD die with an active element according to the design of FIG. 4 within an integrated photonics silicon chip (IPSC) according to an embodiment of the invention;

FIG. 6A depicts a schematic of an IPSC showing the optical fiber and ISD sections according to an embodiment of the invention with a thin film active ISD die according to FIG. 4 and dual PWB sections;

FIG. 6B depicts a schematic of an IPSC showing the optical fiber and ISD sections according to an embodiment of the invention with an active ISD die according to FIG. 4 and dual PWB sections;

FIG. 7 depicts a schematic of a micro-machined silicon block (MSB) and ISD assembly absent a common carrier beneath prior to the formation of a photonic wire bond (PWB) according to an embodiment of the invention;

FIG. 8 depicts an alternate integration schematic of a MSB and ISD assembly according to an embodiment of the invention;

FIG. 9 depicts a schematic of a mechanical structure supporting formation of a PWB between an optical fiber within a U- or V-groove formed within a silicon substrate and a facet of an optical semiconductor device mounted upon a carrier according to an embodiment of the invention;

FIG. 10 depicts exemplary three-dimensional direct write optical elements according to embodiments of the invention;

FIG. 11 depicts the transparent window of bismuth-doped iron garnet (BIG) employed as a Faraday rotator of a magnetless waveguide based Faraday rotator/isolator according to embodiments of the invention;

FIGS. 12A to 12C depict writing methodologies for forming regions of reduced refractive index within a material, e.g. BIG, to form a depressed classing optical waveguide within the material;

FIG. 13 depicts photographs of BIG written with laser spots with varying depth for different collar positions of a spherical aberration correction system within the optical path from the laser to the BIG material being written;

FIGS. 14A to 14C depict three-dimensional, lateral and plan view schematics of an alternating spiral-helix laser writing technique according to an embodiment of the invention;

FIG. 15 depicts an optical waveguide formed within BIG according to an embodiment of the invention;

FIG. 16 depicts a plot of insertion loss versus the diameter of the laser writing beam for an optical waveguide formed within bulk material according to an embodiment of the invention disposed between another a pair of standard singlemode optical fibers;

FIG. 17 depicts an optical image of an optical waveguide formed within bulk material according to an embodiment of the invention disposed between another a pair of standard singlemode optical fibers;

FIG. 18 depicts experimental results the polarization rotation through the two BIG waveguides showing no significant variation from the polarization rotation through bulk BIG bulk; and

FIG. 19 depicts measured insertion loss and isolation ratio for a magnetless waveguide isolator designed and manufactured according to embodiments of the invention;

FIG. 20 depicts a schematic of a laser welded magnetless waveguide Faraday rotator according to an embodiment of the invention;

FIG. 21 depicts laser processing steps for forming an optical fiber assembly for a laser welded magnetless waveguide Faraday rotator according to the design depicted in FIG. 20;

FIGS. 22 and 23 depict photographs of an optical fiber assembly for a laser welded magnetless waveguide Faraday rotator according to the design depicted in FIG. 20;

FIG. 24 depicts the impact of fiber polishing on an optical fiber assembly for a laser welded magnetless waveguide Faraday rotator according to the design depicted in FIG. 20;

FIG. 25 depicts an optical fiber sub-assembly with a laser welded magnetless waveguide Faraday isolator attached at the end of the optical fiber according to an embodiment of the invention;

FIG. 26 depicts an optical fiber sub-assembly with a laser welded magnetless waveguide Faraday isolator attached at the end of the optical fiber according to the design depicted in FIG. 25 assembled with a semiconductor laser diode;

FIG. 27 depicts an optical fiber sub-assembly with a laser welded magnetless waveguide Faraday isolator attached at the end of the optical fiber according to the design depicted in FIG. 25 assembled with a wavelength locker photonic integrated circuit and semiconductor laser diode;

FIG. 28 depicts an array of laser welded magnetless waveguide Faraday isolators attached at the ends of optical fibers assembled within a silicon V-groove assembly according to an embodiment of the invention;

FIG. 29 depicts a laser welded magnetless waveguide Faraday isolator integrated within an optical fiber connector according to an embodiment of the invention;

FIG. 30 depicts optical fiber sub-assemblies with laser welded magnetless waveguide Faraday isolator with cylindrical and square profiles attached at the end of optical fibers according to embodiments of the invention; and

FIGS. 31 and 32 depict polarisation insensitive optical isolator and optical circulator designs according to embodiments of the invention employing optical fiber coupled laser welded magnetless waveguide Faraday rotators according to the design depicted in FIG. 20.

### DETAILED DESCRIPTION

The present invention is directed to photonic components and more particularly to establishing methods, devices and systems exploiting hybrid integration methodologies, structures and techniques integrating active photonic components discretely or in combination with other active photonic elements and/or passive photonic components exploiting micro-optical elements and/or photonic wire bonds discretely or in combination with providing optical elements for integration with waveguide structures that are directly written or patterned.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment,” “an embodiment,” “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may,” “might,” “can” or “could” be included, that particular component, feature, structure, or characteristic is not required to be included.

Reference to terms such as “left,” “right,” “top,” “bottom,” “front,” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including,” “comprising,” “consisting” and grammatical variants thereof do not preclude the addition of one or more components, features, steps, integers, or groups thereof and that the terms are not to be construed as specifying components, features, steps, or integers. Likewise, the phrase “consisting essentially of,” and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional elements.

Within the prior art, see for example U.S. Pat. No. 8,903,205 entitled “Three-Dimensional Freeform Waveguides for Chip-Chip Connections”, optical waveguide structures (referred to a photonic wire bonds or PWBs) are described which are formed from one or more materials which can be processed with a high-resolution, three-dimensional structuring technique to generate optical waveguides that can be directly optically connected or optically connected via special connecting structures from one optical waveguide (e.g. an optical fiber or integrated optical waveguide) to another optical waveguide (e.g. an optical fiber or integrated optical waveguide).

The inventors have established methods and embodiments for the optical interconnection between two or more optical waveguides and/or optical components upon a common platform through hybrid integration methodologies, structures and techniques integrating active photonic components discretely or in combination with other active photonic elements and/or passive photonic components exploiting micro-optical elements and/or photonic wire bonds.

Within the embodiments of the invention the inventors refer to the term “hybridly integrated.” This may, within some embodiments of the invention, refer to, but not be limited to, the “integration” of an optical element onto a substrate by attaching the optical element or another element physically integrated with the optical element to the substrate (platform) such that the optical element is retained in position. Such attachment means may include, but not be limited to, soldering, epoxy, van der Waals forces, electrostatic attachment, magnetic attachment, physical interlocking and friction. Accordingly, in these embodiments of the invention the optical element being hybridly integrated may be viewed as being implemented within a parallel manufacturing process to the other optical element(s) prior to being co-assembled. This parallel manufacturing process may employ one or more processes selected from the group comprising, but not limited to, liquid phase epitaxy (LPE), metal organic chemical vapor deposition (MOCVD), organometallic vapour-phase epitaxy (OMVPE), selective area epitaxy, an additive manufacturing process, a non-additive manufacturing process, crystal growth, doping, induced damage, etching, doping and deposition.

This may, within other embodiments of the invention, refer to, but not be limited to, the “integration” of an optical element onto a substrate using a different manufacturing methodology and/or techniques to those employed in forming other optical components upon the substrate. For example, this may employ employing a LPE process to form the other optical element upon the substrate wherein the optical component upon the substrate was formed by MOCVD or vice-versa. Alternatively, both the optical component and other optical component may be formed using the same manufacturing methodology or a combination of manufacturing methodologies. These manufacturing methodologies may employ one or more processes selected from the group comprising, but not limited to, LPE, MOCVD, OMVPE, selective area epitaxy, an additive manufacturing process, a non-additive manufacturing process, crystal growth, doping, induced damage, etching, doping, deposition, an additive manufacturing process and a non-additive manufacturing process. Accordingly, in these embodiments of the invention the optical element being hybridly integrated may be viewed as being implemented within one or more further processing stages of the same manufacturing process as the other optical element(s).

An additive manufacturing methodology may, within embodiments of the invention employ one or more additive manufacturing (AM) steps selected from the group, using the American Society for Testing and Materials (ASTM) categorizations, material jetting, powder bed fusion, binder jetting, direct energy deposition, material extrusion, sheet lamination, and polymerization. Energy sources for such AM steps may include, but not be limited to, an emitted signal selected from the group comprising infrared (IR) radiation, visible radiation, ultraviolet (UV) radiation, microwave radiation, radio frequency (RF) radiation, X-ray radiation, electron beam radiation, ion beam radiation, an ultrasonic signal, an acoustic signal, a hypersonic signal, a magnetic field and an electric field. Other additive manufacturing techniques may be employed including, for example those described by Habibi et al. in WO/2022/011456 and Packirisamy et al in WO/2018/145194.

However, in each instance the optical waveguide and/or optical component properties require that an optical interface is implemented between the optical waveguide and optical component in order to provide efficient optical coupling between one and the other.

Examples of semiconductors grown using OMVPE may include, but are not limited to, group III-V semiconductors, II-VI semiconductors, group IV semiconductors, and group IV-V-VI semiconductors. Examples of group III-V semiconductors may include AIP, AlN, AlGaSb, AlGaAs, AlGalnP, AlGaN, AlGaP, GaSb, GaAsP, GaAs, GaN, GaP, InAlAs, InAlP, InSb, InGaSb, InGaN, GaInAlAs, GaInAIN, GaInAsN, GaInAsP, GaInAs, GaInP, InN, InP, InAs, InAsSb, and AlInN. Examples of group II-VI semiconductors may include ZnSe, HgCdTe, ZnO, ZnS, and CdO. Examples of group IV Semiconductors may include Si, Ge, and strained silicon. A group IV-V-VI semiconductor may be GeSbTe.

Within embodiments of the invention an optical element may be disposed between a pair of optical waveguides or between an optical waveguide and another optical element. The optical element may be optically passive, optically active, or a combination of optically passive and optically active elements.

Within embodiments of the invention the optical element may be hybridly integrated onto a platform (i.e. a substrate) where the optical waveguide, the pair of optical waveguides and the another optical element are monolithically integrated upon the platform.

Within embodiments of the invention the optical element may be hybridly integrated onto a platform (i.e. a substrate) where the optical waveguide, the pair of optical waveguides and the another optical element are hybridly integrated upon the platform.

Within embodiments of the invention the optical element may be hybridly integrated onto a platform (i.e. a substrate) where the optical waveguide, the pair of optical waveguides and the another optical element are both monolithically and hybridly integrated upon the platform.

Within a non-limiting example an optical waveguide is coupled to a hybridly integrated optical element which provides optical functionality which is either physically not implementable within the optical waveguide or whilst physically implementable within the optical waveguide cannot be implemented with one or more required optical performance characteristics.

Within embodiments of the invention the platform or substrate upon which the integration is performed may be a silicon substrate wherein the one or more optical waveguides upon the platform exploit a silicon nitride core with silicon oxide upper and lower cladding, a SiO₂—Si₃N₄—SiO₂ waveguide structure. Alternatively, the one or more optical waveguides may employ a silicon core with silicon nitride upper and lower claddings. Optionally, the upper cladding may be omitted within other embodiments of the invention.

However, it would be evident that other optical waveguide structures may be employed including, but not limited to, silica-on-silicon, doped (e.g., germanium, Ge) silica core with undoped cladding, silicon oxynitride, polymer-on-silicon, or doped silicon waveguides for example. Additionally, other waveguide structures may be employed including vertical and/or lateral waveguide tapers and forming microball lenses on the ends of the waveguides via laser and/or arc melting of the waveguide tip.

Further, whilst embodiments of the invention are described primarily with respect to silicon-on-insulator (SOI) waveguides by way of example, e.g. SiO₂—Si₃N₄—SiO₂; SiO₂—Ge:SiO₂—SiO₂; or Si—SiO₂, it would be evident that other embodiments of the invention may be employed to couple passive waveguides to active semiconductor waveguides, such as indium phosphide (InP) or gallium arsenide (e), e.g. a semiconductor optical amplifier (SOA), laser diode, etc. Optionally, an active semiconductor structure may be epitaxially grown onto a silicon IO-MEMS structure, epitaxially lifted off from a wafer and bonded to a silicon integrated optical microelectromechanical systems (IO-MEMS) structure, etc.

However, within other embodiments of the invention a variety of waveguide coupling structures coupling onto and/or from waveguides employing material systems that include, but not limited to, SiO₂—Si₃N₄—SiO₂; SiO₂—Ge:SiO₂—SiO₂; Si—SiO₂; ion exchanged glass, ion implanted glass, polymeric waveguides, InGaAsP, GaAs, III-V materials, II-VI materials, SiGe, and optical fiber. Whilst primarily waveguide-waveguide systems have been described it would be evident to one skilled in the art that embodiments of the invention may be employed in aligning intermediate coupling optics, e.g., ball lenses, spherical lenses, graded refractive index (GRIN) lenses, etc. for free-space coupling into and/or from a waveguide device.

Further, whilst embodiments of the invention are described primarily with respect to a silicon substrate it would be evident that other substrates may be employed within other embodiments of the invention. These may include, but not be limited to, a semiconductor, a ceramic, a metal, an alloy, a glass, or a polymer.

A “ceramic” as used herein may refer to, but is not limited to, an inorganic, nonmetallic solid material comprising metal, non-metal or metalloid atoms primarily held in ionic and covalent bonds. Such ceramics may be crystalline materials such as oxide, nitride or carbide materials, elements such as carbon or silicon, and non-crystalline. Exemplary ceramics may include high temperature ceramics or high temperature co-fired ceramics such as alumina (Al2O3), zirconia (ZrO2), and aluminum nitride (AlN) or a low temperature cofired ceramic (LTCC). A LTCC may be formed from a glass-ceramic combination.

A “metal” or “alloy” as used herein may refer to, but is not limited to, a material having good electrical and thermal conductivity. Metals are generally malleable, fusible, and ductile. Metals as used herein may refer to elements, such as gold, silver, copper, aluminum, iron, etc. whilst an alloy as used herein refers to a combination of metals such as bronze, stainless steel, steel, etc.

A “polymer” as used herein may refer to, but is not limited to, is a large molecule, or macromolecule, composed of many repeated subunits. Such polymers may be natural and synthetic and typically created via polymerization of multiple monomers. Polymers through their large molecular mass may provide unique physical properties, including toughness, viscoelasticity, and a tendency to form glasses and semi-crystalline structures rather than crystals.

A “glass” as used herein may refer to, but is not limited, to a non-crystalline amorphous solid. A glass may be fused quartz, silica, a soda-lime glass, a borosilicate glass, a lead glass, an aluminosilicate glass for example. A glass may include other inorganic and organic materials including metals, aluminates, phosphates, borates, chalcogenides, fluorides, germanates (glasses based on GeO2), tellurites (glasses based on TeO2), antimonates (glasses based on Sb2O3), arsenates (glasses based on As2O3), titanates (glasses based on TiO2), tantalates (glasses based on Ta2O5), nitrates, carbonates, plastics, and an acrylic.

Whilst within the following embodiments of the invention structures are described as being formed within the substrate for the insertion of other optical elements and/or the insertion of materials which are subsequently processed to form an optical interconnection through etching based upon the embodiments of the invention being described with respect to silicon as a substrate it would be evident that within other embodiments of the invention according to the substrate that other manufacturing processes may be employed to form the structures either through the selective removal of material, e.g. through ablation for example, through the selective addition of material, e.g. deposition, sintering, fusing, etc., through the initial shaping of the material, e.g. through stamping or fabrication by deposition onto a template etc. or a combination thereof.

Within embodiments of the invention an optical waveguide and/or optical element may be formed or partially formed using doping to selectively increase or decrease the refractive index of the material in dependence upon the dopant employed and its concentration within the material doped. Within semiconductors such dopants are typically other semiconductor materials however a dopant may be any element or combination of elements achieving the desired result such as hydrogen, deuterium, erbium, and ytterbium for example. In some embodiments multiple doping profiles may be employed to create the desired final refractive index profile. In some embodiments of the invention this doping may trigger the formation of vacancies within the lattice of the material or substitute an element into the lattice of the material.

Within embodiments of the invention an optical waveguide and/or optical element may be formed or partially formed using the induction of damage to selectively increase or decrease the refractive index of the material in the damaged region in dependence upon the degree of damage induced. In some embodiments multiple damage profiles may be employed to create the desired final refractive index profile. In embodiments of the invention an aspect of the induction of damage may be employed to tune the location of the induced damage such that, for example, damage reducing a refractive index is induced at a predetermined depth below the surface of the material being damaged. Such damage may be induced from atomic bombardment, e.g. proton bombardment, electron bombardment, ion bombardment, infrared (IR) radiation, visible radiation, ultraviolet (UV) radiation, microwave radiation, radio frequency (RF) radiation, X-ray radiation, electron beam radiation, ion beam radiation, an ultrasonic signal, an acoustic signal and a hypersonic signal. In some embodiments of the invention this induced damage may be the formation of vacancies within the lattice of the material.

Within the following description, photonic wire bonds are described and presented as being formed through, for example, two-photon absorption triggered processes within a liquid photosensitive material to generate the waveguide core and waveguide cladding(s) of the PWB wherein through controlled positioning and movement of the incident beam(s) of light, three-dimensional (3D) optical waveguides (waveguides) which are self-supporting can be generated. The inventors refer to these waveguides as being free-form waveguides as the geometry and/or position of the waveguide can be defined based upon factors including computer aided design (CAD), optical simulations, and the physical positions of the optical elements to which the PWB interfaces at either end.

Accordingly, the PWBs can support mode field diameter (MFD) conversion and matching position along these PWBs (interconnection links) between independent optical circuits components such as singlemode or multimode optical waveguides (e.g. optical fiber waveguides referred to as optical fibers within this specification) and/or planar integrated waveguides of different material systems and designs, referred to as integrated optical waveguides or simply waveguides within this specification such as two-dimensional (2D) or planar waveguides and 3D or channel waveguides as referred to in the art.

Subsequent to placement of the two optical elements to be connected with the PWB a PWB manufacturing system employing automated moving stages and/or positioning arms in combination with image processing and pattern recognition algorithms locates the waveguide cores, for example, of the optical elements being interconnected and then locally prints the photonic wire bonds, referred as they function as an optical/photonic equivalent between waveguide cores to be interconnected as do electrical wirebonds between electrical structures to be interconnected. This process provides low-cost, low-loss optical interconnections within production-friendly embodiments that are scalable for mass-volume production.

Importantly, the integration of a photonic wire bond between waveguides provides for a defined and repeatable alignment between the waveguides such that the PWB can “absorb” mismatches arising from manufacturing tolerances which would otherwise either lead to high insertion losses or increased costs of manufacturing to achieve tighter manufacturing tolerances.

However, it would be evident to one of skill in the art that other direct write or additive manufacturing technique may be employed to generate the PWB(s) without departing from the scope of the invention. Further, whilst the light-based methodologies described and depicted exploit what the inventors refer to later in this specification as a “pool” of the light-sensitive material(s) to form the waveguide core/cladding it would be evident that within other embodiments of the invention alternate deployment means for a selectively curing a material may be employed such as other optical or non-electrical techniques. “Curing” may for example be through cross-linking, optically induced polymerization, electron bombardment polymerization, thermal polymerization, ultrasonically triggered polymerization etc. Optionally, two or more beams may be employed to “write” the PWB wherein each beam is at an intensity insufficient to trigger the transition in the material from liquid to solid but the overlapping point of these beams has sufficient intensity to trigger the transition. Optionally, a single beam may be employed with a very shallow focal depth such that in the unfocussed regions the power density is insufficient to trigger the transition in the material from liquid to solid but the focal point has sufficient power density to trigger the transition.

Optionally, it would be evident that other direct write techniques such as additive manufacturing techniques may be employed without a “pool” of material. For example, WO/2018/145,194 entitled “Methods and Systems for Additive Manufacturing” describes techniques referred to as Selective Spatial Solidification to form a 3D piece-part directly within a selected build material whilst Selective Spatial Trapping “injects” the build material into a manufacturing system and selectively directs it to accretion points in a continuous manner.

Within the following sections exemplary PWB interconnections are described with respect to the interconnection of optical elements/optical waveguides. It would be evident to one of skill in the art that the PWB interconnection designs and methodologies as described may be applied to other optical interconnections either discretely or in combination without departing from the scope of the invention.

Within this section the specific context of writing a photonic wire bonding link between an optical fiber and an integrated photonics silicon nitride waveguide is described and presented in order to present the techniques for forming a photonic wire bond. However, it would be evident that in order to provide a fixed and repeatable alignment between a first optical waveguide (e.g. an optical fiber in a first instance or silicon nitride waveguide in a second instance) and a second optical waveguide (e.g. a silicon nitride waveguide in the first instance and a semiconductor waveguide in the second instance) allowing the implementation of automated photonic wire bonding writing recipes essential to mass-production schemes requires that the first optical waveguide and second optical waveguide be positioned/retained in a similarly automated/mass production manner.

However, it would be evident to one of skill in the art that the optical fiber represents an example of an optical element which is coupled to an optical waveguide upon a substrate. In fact within some embodiments of the invention the optical element may be a short section of an optical fiber such as a graded index fiber, where the “core” has a refractive index that decreases with increasing radial distance from the optical axis of the fiber, a photonic crystal fiber (PCF), a photonic-bandgap fiber PCF which confines photonic signals by band gap effects, a holey fiber PCF using air holes in their cross-sections, a hole-assisted fiber PCF which guides photonic signals by a conventional higher-index core modified by the presence of air holes, and a Bragg fiber which is photonic-bandgap fiber formed by concentric rings of material.

For example, in the instance of an optical fiber the inventors have worked to develop custom U-groove structures formed within 200 mm (8″) diameter silicon-on-insulator (SOI) wafers where the thickness of the top silicon slab is engineered to make the optical fiber cores co-planar and co-axial with the silicon nitride waveguide cores to which they to be coupled thereby improving the positional alignment and reducing the misalignment that the photonic wire bond (PWB) is required to absorb. Descriptions with respect to such structures are described and depicted within WO/2020/093136 entitled “Structures and Methods for Stress and Gap Mitigation in Integrated Optical Microelectromechanical Systems” for example.

Accordingly, within embodiments of the invention U-grooves are etched into a top silicon slab using any suitable anisotropic patterning process(es), such as Deep Reactive Ion Etching (DRIE) for instance, with a Buried Oxide (BOX) layer acting as an etch-stop to provide a repeatable etch depth. These U-grooves have their lengths, widths and depths engineered to tightly receive and host the stripped ends of optical fibers (e.g. 125 μm outer diameter singlemode optical fibers such as Corning SMF-28 for example), position them to within a specified tolerance (e.g. ±1 μm in vertical and lateral directions) from the axis of the silicon nitride waveguides whilst providing sufficient space for the controlled dispense and capillary-force driven infiltration of structural (and/or optical) UV (and/or thermally) curable adhesives to fix the optical fibers within the U-grooves. A controlled dispense is engineered to provide for both thermo-mechanical stability of the fiber in the U-Groove and an optimal index contrast to enhance the fiber core detection by the vision system of the photonic wire bonding writing tool. The U-Grooves lengths are also engineered to set a repeatable distance in the horizontal direction between the end facet of the optical fiber and the opposing silicon nitride waveguide.

However, the optical fibers may be fixed into position with other mechanisms such as metallized fiber/solder to metallization on the silicon substrate or optical waveguide stack, attachment of a top-cover over the U-grooves and optical fibers etc. Further, the dimensions of exemplary embodiments of the invention are provided with respect to those specific embodiments of the invention and may be varied within the same embodiments of the invention or other embodiments of the invention without departing from the scope of the invention.

Within embodiments of the invention as depicted and described below the interface region between the U-groove structure(s) and the optical waveguide(s) comprises a customized receptacle (referred to as a pool by the inventors) such that this pool can be filled with one or more materials from which the PWB is formed is located between the optical fibers and the silicon nitride waveguides. These pools receive and contain, for example, a liquid photoresist from which the photonic wire bonding core is written with a UV direct write process. The dimensions of the pools provide for line-of-sight visual access of the PWB manufacturing system to the cores of the optical fiber and silicon nitride waveguide so that the vision system of the PWB writing tool can locate them and lock onto them. The dimensions of the pools provide for repeatable, sufficient, yet minimal volume of the photoresist to be dispensed and maintained in location to ensure a repeatable PWB writing process.

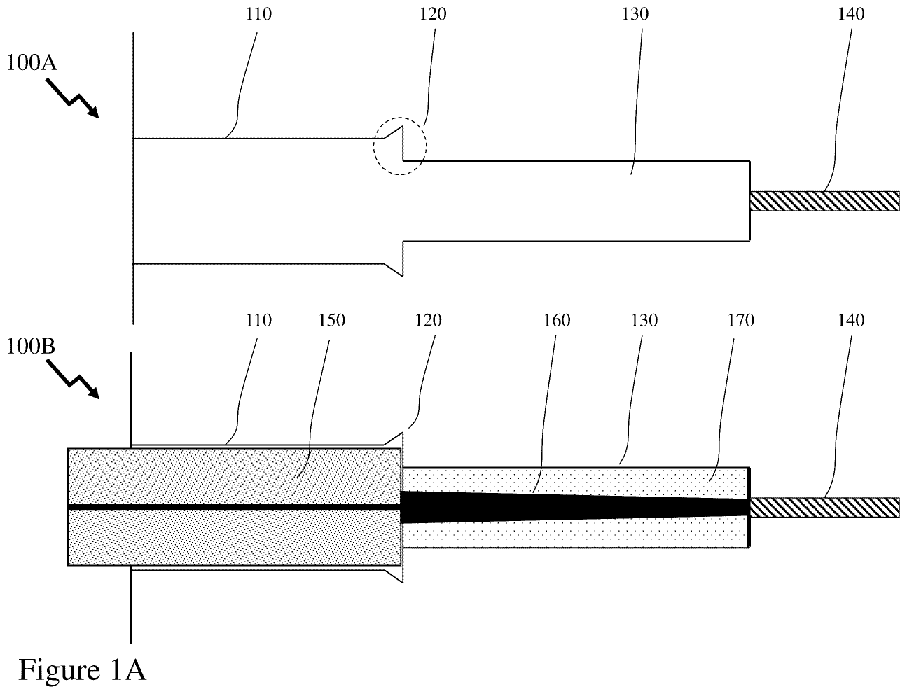

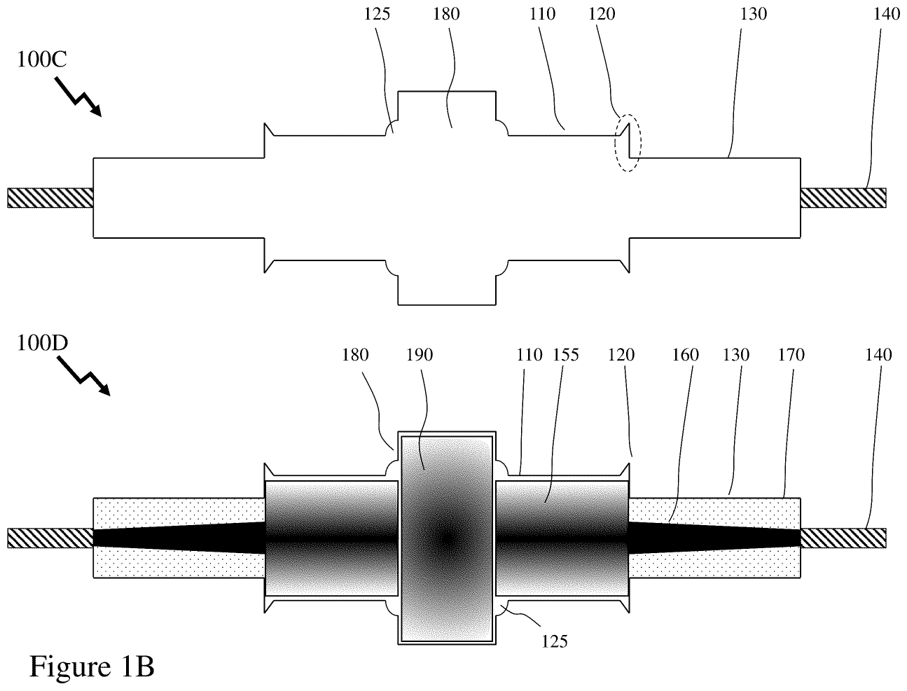

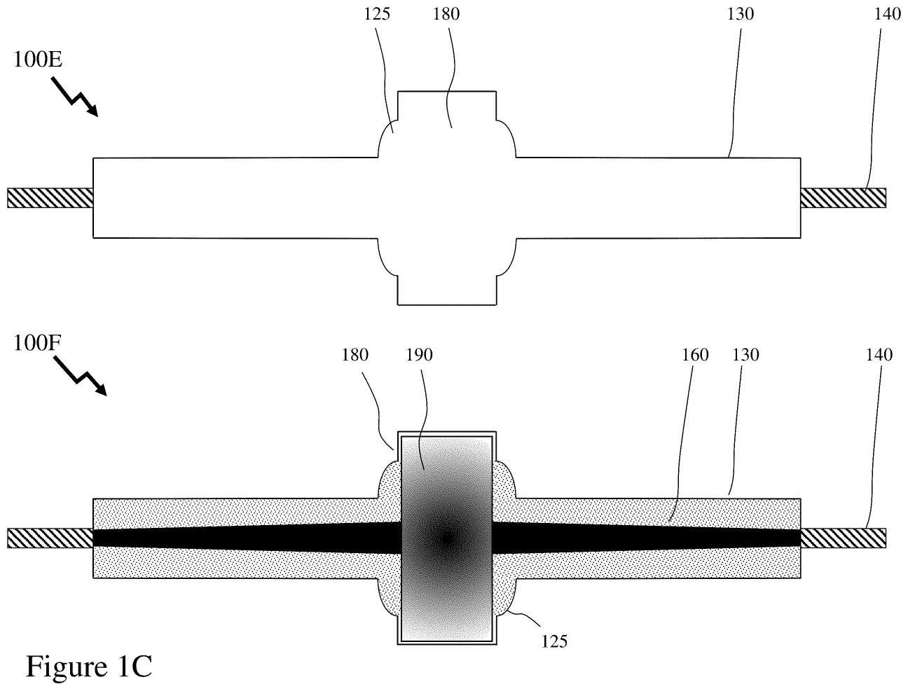

Referring to FIG. 1A there are depicted first and second Views 100A and 100B of an exemplary “pool” based PWB structure at an initial photonic integrated circuit (PIC) manufacturing stage and after assembly with optical fiber and formation of the PWB respectively according to an embodiment of the invention. Accordingly, referring to first View 100A the optical interface portion of the PIC relating to U-groove/optical fiber/PWB is depicted showing the Optical Waveguide 140 of the PIC, the U-Groove 110 (or V-Groove or other structure to locate and retain an optical fiber), and the Pool 130 within which the liquid from which the PWB will be formed.

The Pool 130 is narrower than the U-Groove 110 such that a Butt Stop 120 is formed which enables for provisioning of a fixed and repeatable separation between the end facet of the optical fiber when inserted and the facet of the Optical Waveguide 140. The sidewalls of the Pool 130 have engineered sizes and shapes to allow for adequate line-of-sight visual access for the vision system to the optical fiber core whilst improving the control over the optical and/or structural liquid dispense by acting as mechanical and capillary stoppers.

The Butt Stops 120 as depicted are further patterned with, optional, structures which the inventors refer to as “butterfly structures” which enable removal of the rounded (in the instance of a U-Groove) bottom wall shapes typical of anisotropic patterning processes like DRIE, which would otherwise impede on proper core-core alignment between waveguides and optical fibers by causing the latter to lift as they are butted against the Butt Stop 120 (U-groove-to-pool separation sidewall).

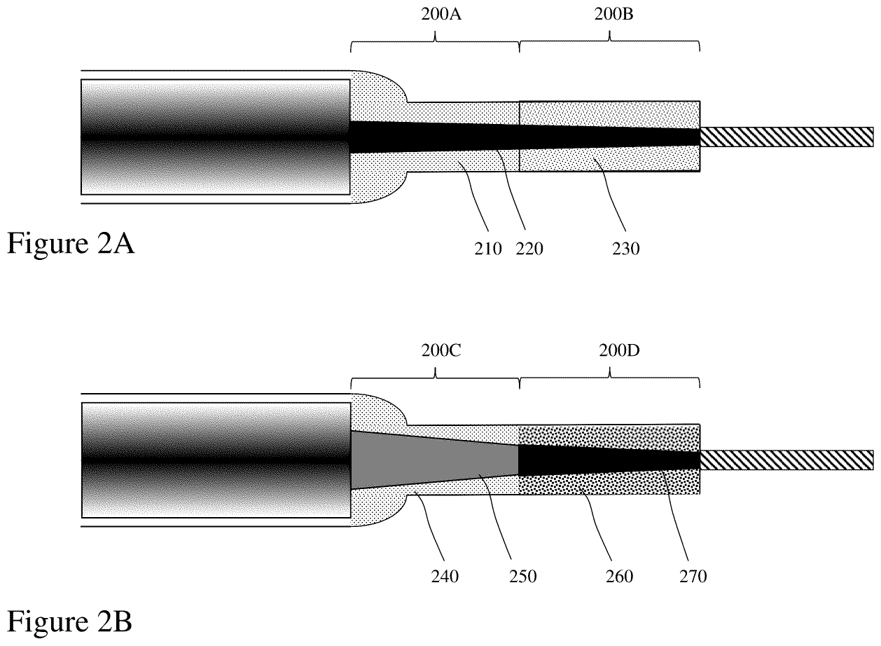

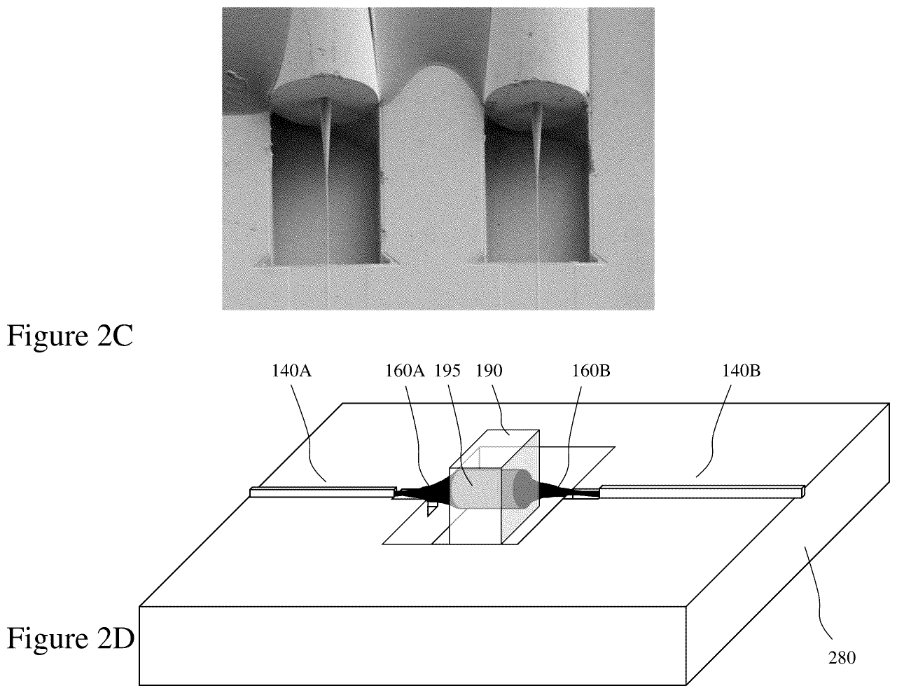

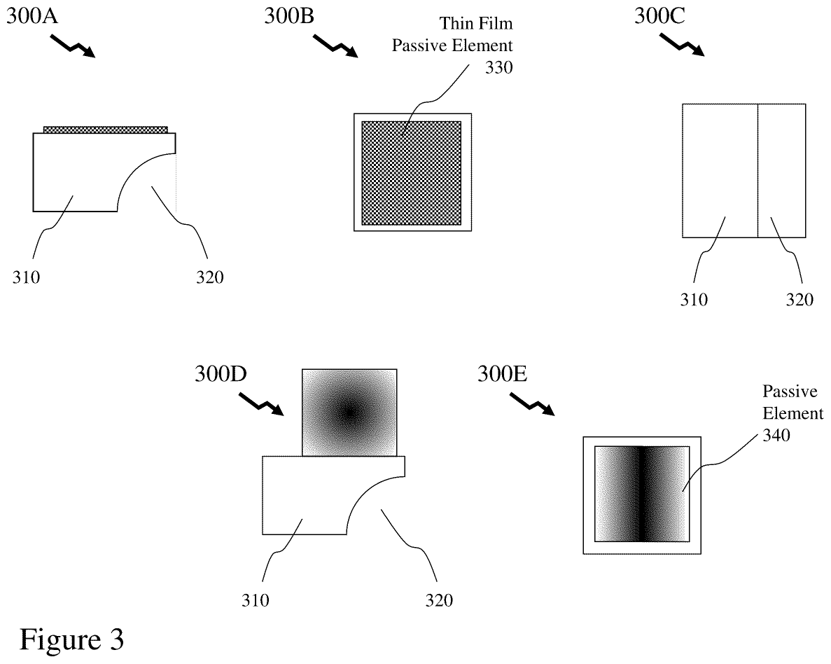

Subsequently, as depicted in second View 100B, the Optical Fiber 150 is inserted such that the end facet of the Optical Fiber 150 forms the fourth and initially missing wall of the pool for the liquid with the Pool 130. Accordingly, a Pool 130 can be embodied by backing up the Optical Fiber 150 in the U-Groove 110 (or V-groove) as depicted in FIGS. 2 and 3, respectively. In this manner the liquid is dispensed into a region with sidewalls limited its flow where the properties of the liquid are such that capillary wicking of the liquid out into the U-Groove 110 is limited or avoided. However, in other instances, this wicking of the liquid may be employed to provide a curable adhesive layer between the silicon (or other material) substrate within which the U-Groove 120 is formed and the Optical Fiber 150. Optionally, the Optical Fiber 150 may be fixed into position within the U-Groove 110 prior to the formation of the PWB 160 between the end facet of the Optical Fiber 150 and the facet of the Optical Waveguide 140 or within other embodiments of the invention an overall curing of another material, Filler 170, employed to provide a cladding of the PWB 160.

Accordingly, the U-groove-pool-waveguide structure are implemented through a microfabrication process exploiting process and/or design building blocks/elements from a proprietary MEMS fabrication process of one applicant, see for example WO/2020/093136 entitled “Structures and Methods for Stress and Gap Mitigation in Integrated Optical Microelectromechanical Systems.” Accordingly, the U-Groove-Pool and U-Groove-Pool-Waveguide alignments are established by design and are hardcoded onto microfabrication photomasks thereby established repeatability of lateral and longitudinal geometry aspects whilst those vertical to the plane of the U-Groove-Pool-Waveguide are established through the design of the optical waveguide stack, underlying stack elements (e.g. BOX), silicon wafer etc. and processing tolerances and/or integration of etch stops etc.

Referring to FIG. 1B there are depicted first and second Views 100C and 100D of a mechanical structure for the formation of a PWB 160 between a graded index optical fiber (GRIOF) 155 within a U- or V-groove 110 formed within a silicon substrate and an Optical Waveguide 140 formed upon the silicon substrate according to an embodiment of the invention wherein the GRIOF 155 is coupled to another Optical Element 190 which may be passive or active according to the specific requirements of the overall optical circuit the mechanical structure forms part of. As depicted in first and second Views 100C and 100D a pair of U- or V-grooves 110 are formed either side of an Opening 180 within which the Optical Element 190 is disposed. Accordingly, an optical signal at the left hand side of the structure depicted in first and second Views 100C and 100D is initially guided within a first Optical Waveguide 140 before being coupled to a first GRIOF 155 via a first PWB 160 wherein it is coupled to the Optical Element 190. From the Optical Element 190 the optical signals processed by the Optical Element 190 are coupled to a second GRIOF 155 and therein via a second PWB 160 to a second Optical Waveguide 140.

Within an embodiment of the invention the GRIOF 155 acts as a graded index (GRIN) lens whilst within other embodiments it is replaced with a GRIN lens. Within embodiments of the invention the GRIOF 155 or GRIN lens may be circularly symmetric in refractive index profile whilst within other embodiments of the invention it may circularly asymmetric.

In contrast, as depicted in FIG. 1C in first and second Views 100E and 100F the PWBs 160 may be able to accommodate the required optical mode geometry adjustments then the Optical Waveguides 140 are coupled to the Optical Element 190 via the PWBs 160 directly. The PWB may implement a circularly symmetric mode transformation along its length or it may implement a non-circularly symmetric mode transformation.

Optionally, the PWB 160 may be implemented in two or more steps using different material combinations for the different sections. For example, one section may be air clad whilst the other section is clad with a cladding material as depicted in FIG. 2A. Accordingly, the PWB is depicted as comprising of a first section 200A and a second section 200B wherein the PWB Core 220 is formed within both from the same material but first section 200A is clad with first Material 210 and second Section 200B is clad with a second Material 230. One of the first Material 210 and second Material 230 may be dispensed and cured through the use of temporary “pool wall” or this may be omitted if the one of the first Material 210 and second Material 230 has a high enough viscosity.

In contrast the PWB in FIG. 2B is depicted as comprising a first section 200C wherein the PWB is formed from a third Material 240 clad in a fourth Material 250 whilst in the second section 200D the PWB is formed from a fifth Material 260 clad in a sixth Material 270. In this instance one of the third Material 240 and optionally fourth Material 250 or fifth Material 260 and optionally sixth Material 270 are dispensed and cured through the use of a temporary “pool wall” which is removed prior to forming the other part of the PWB. In other embodiments of the invention the “pool wall” may be omitted where the fourth material 250 or sixth material 270 are initially dispensed to fill the pool but the PWB core is only written to part way along the pool before the material is removed, the next material added etc. Optionally, the third Material 240 and fifth Material 260 may be the same with different PWB core materials within other embodiments of the invention.

Now referring to FIG. 2C there is depicted an optical micrograph of a pair of optical fibers which are optically coupled to a pair of optical waveguides via a pair of PWBs. The PWBs may be in their final form with an air cladding or may be part through processing prior to the dispensing of a cladding around them.

Referring to FIG. 2D there is depicted a perspective schematic of an interconnection between an input waveguide 140A and an output waveguide 140B via an Optical Element 190 wherein the interconnection between the input waveguide 140A and Optical Element 190 is via a first PWB 160A and the interconnection between the output waveguide 140B and the Optical Element 190 is via a second PWB 160B. The Optical Element 190 comprising an Optical Structure 195 within where the Optical Element 190 is depicted within an opening within the Substrate 280, such as Opening 180 depicted in FIG. 1C.

Within exemplary embodiments of the invention the optical waveguides, e.g., Optical Waveguide 140 in FIG. 1, employed for the PICs and therein coupling to and/or from other optical elements with PWBs are based upon a 450 nm thick Silicon Nitride (SiₓN_{y}, referred to subsequently as SiN for ease of reference) core symmetrically clad with 3.2 μm of Silicon Oxide (SiO₂) above and below. This material choice provides an advantage over waveguides with silicon cores in regard of PWBs because the lower core-clad refractive index contrast results in larger mode field diameters (MFD) than silicon waveguides. Larger MFDs allow for more overlap in the interconnection region, which results in increased tolerances with respect to misalignment between the PWB and the SiN cores to achieve low-loss optical links.

Within embodiments of the invention the SiN waveguide cores are patterned with tapers in the region close to the interface with the PWB core in order to increase the MFD further, thereby providing an additional relaxation of the core-to-core alignment constraints and tolerances. The relatively larger PWB cores provide improved scalability of the technology towards shorter wavelengths, making the technology applicable to PIC devices operating in different wavelength ranges including the L, C, S, E and O-bands of the infrared telecommunications spectrum, namely 1565 nm-1625 nm, 1530-1565 nm, 1460-1530 nm, 1360-1460n and 1260 nm-1360 nm respectively.

Within embodiments of the invention the SiN waveguide cores are patterned with square cross-section tapers in the region closest to the interface with the PWB core in order to provide mode fields with angular symmetry such that when coupled with photonic wire bonding cores with cylindrical symmetry, optical interfaces with low polarization sensitivity are produced.

Within FIGS. 1B, 1C, 2A, 2B and 2D the optical element, Optical Element 190, is depicted as being mounted directly upon the same substrate as that of the optical waveguides, e.g. Optical Waveguide 140, and within which Pools 130, U-Grooves 110 and the Opening 180 are formed. However, within other embodiments of the invention the Optical Element 190, whether providing a passive function, active function or a combination thereof, the Optical Element 190 may be formed upon an intermediate support die (ISD). The ISD may provide appropriate characteristics such as thermal expansion coefficient, relative to that provided by the substrate.

Referring to FIG. 3 there are depicted in first to third Images 300A to 300C respectively a thin film passive optical component employing an intermediate support die (ISD) according to an embodiment of the invention. First to third Images 300A to 300C depicting a front elevation (i.e. along the axis of optical propagation), plan elevation and bottom elevation of the ISD comprising a Carrier 310 and Thin Film Passive Element 330. Formed within the lower surface of the Carrier 310 is a Recess 320 allowing for either an increased volume of material under the ISD between the Carrier 310 and the substrate and/or accommodation excess material from the attachment of the ISD to the substrate to be accommodated, e.g. with Opening 180 as depicted in FIGS. 1C and 2D respectively.

As depicted in first and second Images 300A and 300B the Thin Film Passive Element 330 is a thin film based passive element, wherein the Thin Film Passive Element 330 may form a planar waveguide, be of a thickness larger than the optical beam propagating through it, or be of a thickness less than the optical beam propagating through it such that only a portion of the optical signal propagating is coupled to the Passive Element 330.

In contrast, in fourth and fifth Images 300D and 300E respectively, representing front elevation (i.e. along the axis of optical propagation) and plan elevation for a Passive Element 340 having a height larger than the optical beam being propagated through it. Within embodiments of the invention the optical beam may be along a geometric axis of the Passive Element 340 or it may propagate along a propagation axis offset from a geometric axis of the Passive Element 340.

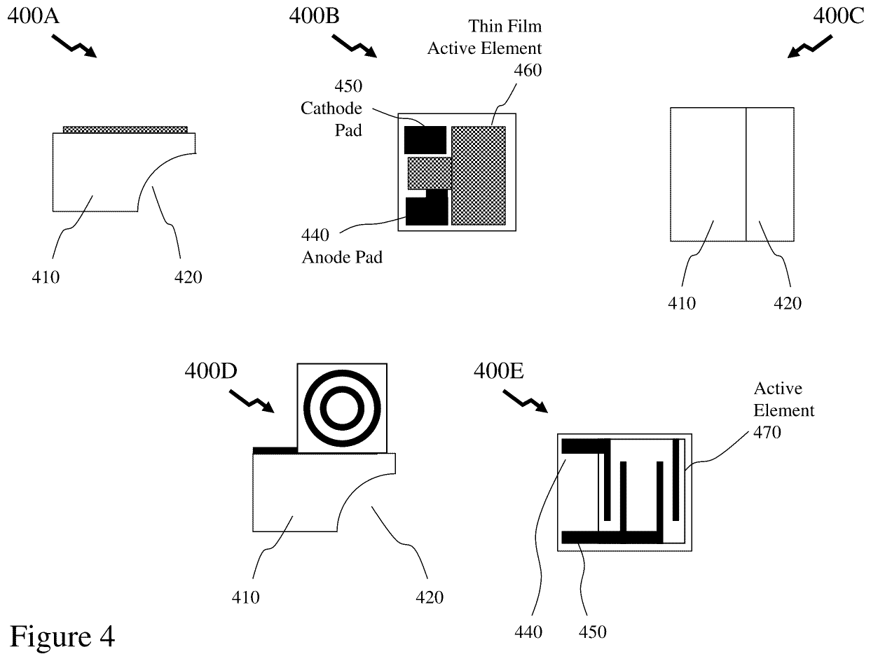

Referring to FIG. 4 there are depicted in first to third Images 400A to 400C respectively a thin film active optical component employing an intermediate support die (ISD) according to an embodiment of the invention. First to third Images 400A to 400C depicting a front elevation (i.e. along the axis of optical propagation), plan elevation and bottom elevation of the ISD comprising a Carrier 410 and Thin Film Active Element 460. Formed within the lower surface of the Carrier 410 is a Recess 420 allowing for either an increased volume of material under the ISD between the Carrier 410 and the substrate and/or accommodation excess material from the attachment of the ISD to the substrate to be accommodated, e.g. with Opening 180 as depicted in FIGS. 1C and 2D respectively. The Thin Film Active Element 460 being electrically coupled to Anode Pad 440 and Cathode Pad 450 respectively although according to the functionality and design of the Thin Film Active Element 460 only a single electrical connection may be provided, as the Thin Film Active Element 460 has a ground contact formed through the Carrier 410 and therein to the substrate or there may be three or more electrical connections.

As depicted in first and second Images 400A and 400B the Thin Film Passive Element 430 is a thin film based passive element, wherein the Thin Film Active Element 460 may form a planar waveguide, be of a thickness larger than the optical beam propagating through it, or be of a thickness less than the optical beam propagating through it such that only a portion of the optical signal propagating is coupled to the Thin Film Active Element 460 being electrically coupled to Anode Pad 440 and Cathode Pad 450 respectively although according to the functionality and design of the Thin Film Active Element 460 only a single electrical connection may be provided, as the Thin Film Active Element 460 has a ground contact formed through the Carrier 410 and therein to the substrate or there may be three or more electrical connections.

In contrast, in fourth and fifth Images 400D and 400E respectively, representing front elevation (i.e. along the axis of optical propagation) and plan elevation for an Active Element 470 having a height larger than the optical beam being propagated through it. Within embodiments of the invention the optical beam may be along a geometric axis of the Active Element 470 or it may propagate along a propagation axis offset from a geometric axis of the Active Element 470. The Active Element 470 being electrically coupled to Anode Pad 440 and Cathode Pad 450 respectively although according to the functionality and design of the Active Element 470 only a single electrical connection may be provided, as the Active Element 470 has a ground contact formed through the Carrier 410 and therein to the substrate or there may be three or more electrical connections.

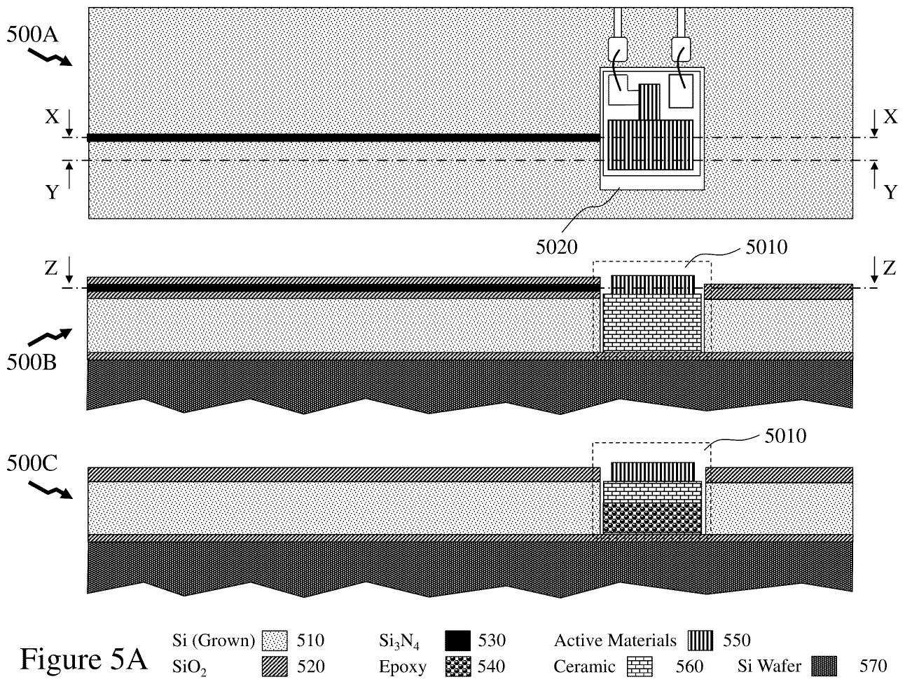

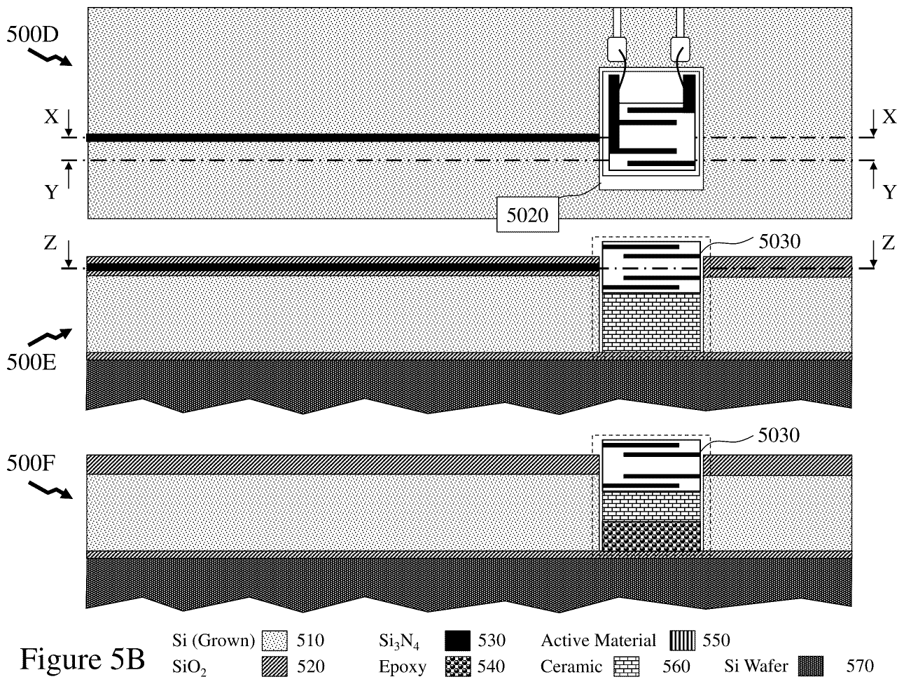

Now referring to FIG. 5A there is depicted schematically the integration of an ISD die with a thin film active element according to the design of FIG. 4 within an integrated photonics silicon chip (IPSC) according to an embodiment of the invention. Accordingly, the ISD 5010 employs a design concept as depicted in first to third Images 400A to 400C respectively with a Thin Film Active Element 460 which is not identified within FIG. 5A.

Accordingly, within FIG. 5A there is depicted Plan 500A together with first and second Cross-Sections 500B and 500C respectively along Sections X-X and Y-Y, respectively. Plan 500A being along Section Z-Z within first Cross-Section 500B. Accordingly, the ISD 5010 is depicted inserted into a Cavity 5020 formed within the device stack formed atop the BOX (SiO2 520) formed upon the Si Wafer 570. Accordingly, the Cavity 5020 is etched into the Si (Grown) 510, SiO2 520, and Si₃N₄ 530 grown atop the BOX. The ISD 5010 is attached via Epoxy 540 within the recess in the lower surface of the ISD Carrier formed from Ceramic 560 upon which are formed the electrical contacts (Anode Pad 440 and Cathode Pad 450) together with the Thin Film Active Element 460 formed from the Active Material(s) 550.

Within other embodiments of the invention according to the design of the ISD Carrier and the structure grown on the Si Wafer 570 the cavity may be formed by etching to a shallower depth than the BOX or alternatively within other embodiments of the invention the cavity may be formed by etching to a deeper depth than the BOX such that cavity also extends down into the Si (Grown 510).

Now referring to FIG. 5B there is depicted the integration of an ISD die with an active element according to the design of FIG. 4 within an integrated photonics silicon chip (IPSC) according to an embodiment of the invention. Accordingly, the ISD 5030 employs a design concept as depicted in fourth and fifth Images 400D and 400E respectively with an Active Element 470 which is not identified within FIG. 5A.

Accordingly within FIG. 5B there is depicted Plan 500D together with first and second Cross-Sections 500E and 500F respectively along Sections X-X and Y-Y, respectively. Plan 500A being along Section Z-Z within first Cross-Section 500E. Accordingly, the ISD 5030 is depicted inserted into a Cavity 5020 formed within the device stack formed atop the BOX (SiO2 520) formed upon the Si Wafer 570. Accordingly, the Cavity 5020 is etched into the Si (Grown) 510, SiO2 520, and Si₃N₄ 530 grown atop the BOX. The ISD 5030 is attached via Epoxy 540 within the recess in the lower surface of the ISD Carrier formed from Ceramic 560 upon which are formed the electrical contacts (Anode Pad 440 and Cathode Pad 450) together with the Thin Film Active Element 460 formed from the Active Material(s) 550.

Within other embodiments of the invention according to the design of the ISD Carrier and the structure grown on the Si Wafer 570 the cavity may be formed by etching to a shallower depth than the BOX or alternatively within other embodiments of the invention the cavity may be formed by etching to a deeper depth than the BOX such that cavity also extends down into the Si (Grown 510).

An assembly process for the IPSC and ISD employs the ISDs being inserted into the cavities within the upper surface of the IPSC. This may be with pick-and-place tools can be active or passive and is engineered to optimize the optical to the waveguide facets. The attachment of the ISDs is made using an epoxy which may be conductive, non-conductive, ultraviolet (UV) curable, thermally curable etc. Other attachment techniques may be employed but with increased complexity. The design of the ISD Carrier is such that its thickness aligns the active element, e.g. Thin Film Active Element 460 or Active Element 470 with the optical waveguide(s) it is intended to be coupled to/from.

As depicted in FIGS. 5A and 5B the ISD 5010 and ISD 5030 are coupled to a single optical waveguide although it would be evident that an input and/or an output side may both contain a single optical waveguide and/or multiple optical waveguides disposed across the substrate. As depicted in FIGS. 5A and 5B the ISD 5010 and ISD 5030 are coupled to a single optical waveguide vertically although it would be evident that the input and/or the output side may contain multiple optical waveguide layers disposed vertically with respect to the substrate in other embodiments of the invention.

Within FIG. 5B the Ceramic 560 (i.e. the Carrier 410) of the ISD 5010 is depicted directly abutting the BOX of the IPSC wherein the Epoxy 540 is employed within the Recess 420 of the Carrier 410 and around portions of the periphery of the ISD 5010 within the Cavity 520. Electrical connectivity to the ISD 5010 is achieved by wire bonding the Anode Pad 440 and Cathode Pads 450 to the electrical pads formed upon the surface of the IPSC which are then routed to CMOS electronics within the IPSC or to contacts for connection to external electronics.

Within FIGS. 5A and 5B the ISD is depicted as directly coupled to the optical waveguide(s). Further, only a waveguide on one side of the ISD is depicted although it would be evident to one of skill in the art that optionally other waveguides may be disposed on another other side of the ISD such that optical waveguides are coupled to the Thin Film Active Element 460 and Active Element 470 from multiple directions and/or from one or more waveguides to another waveguide or waveguides via Thin Film Active Element 460 and Active Element 470. It would also be evident that the Thin Film Active Element 460 and Active Element 470 may be replaced with the Thin Film Passive Element 330 and Passive Element 340 respectively.

However, within other embodiments of the invention such as described and depicted in FIGS. 2A, 2B and 2D the ISD may interface to the IPSC via one or more PWBs.

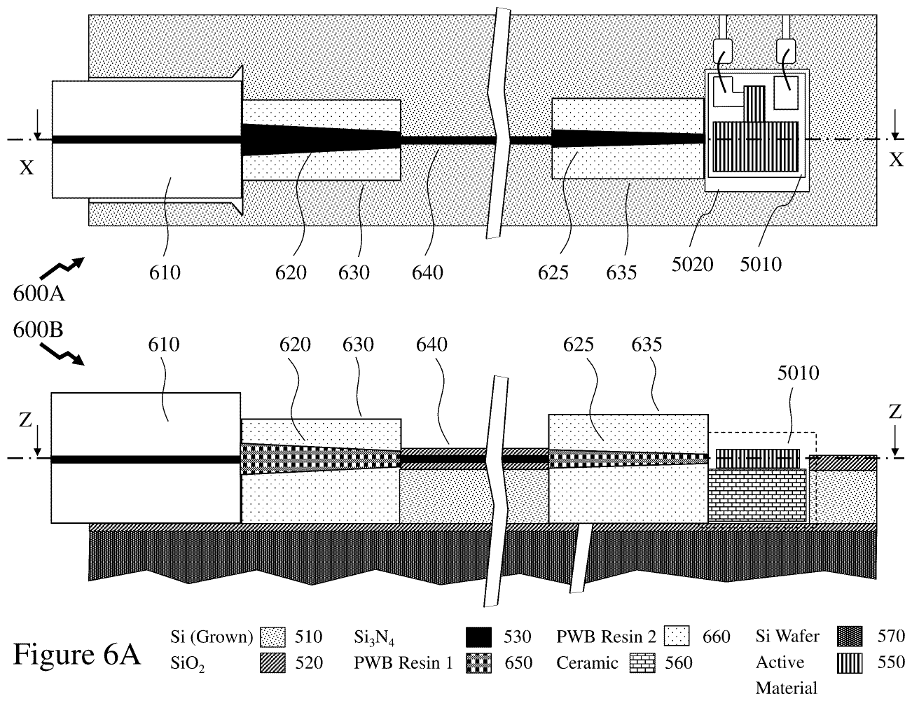

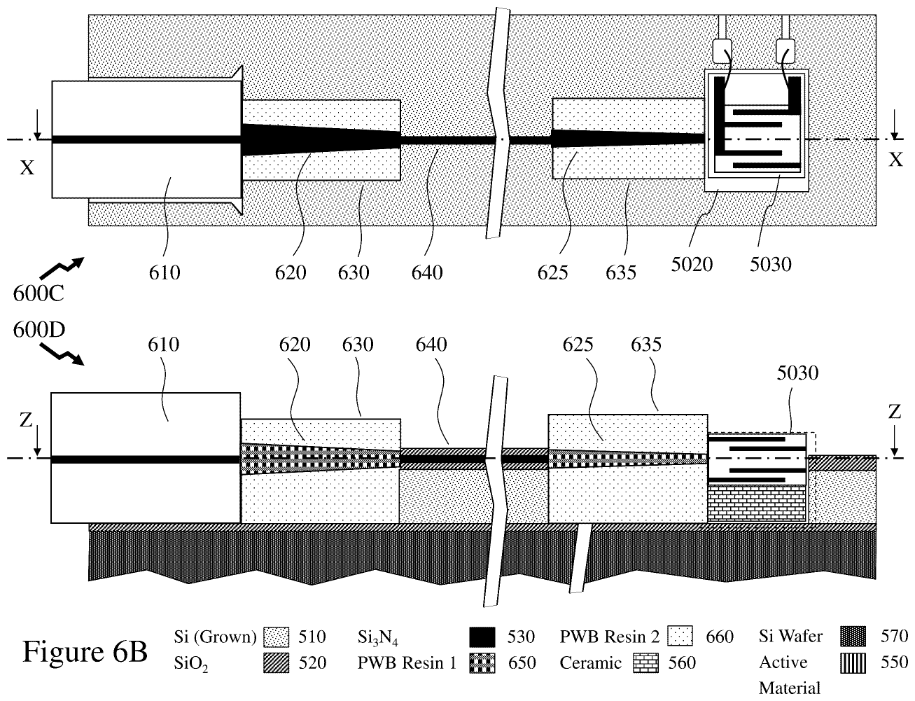

Referring to FIG. 6A there is depicted a schematic of an IPSC showing the optical fiber and ISD sections according to an embodiment of the invention with a thin film active ISD die according to first to third Images 400A to 400C in FIG. 4 and dual PWB sections.

Accordingly, referring to FIG. 6A there is depicted a Plan 600A along section Z-Z and Cross-Section 600B along section X-X of an IPSC showing the optical fiber, PWB and ISD sections. Accordingly, the ISD 5010 is depicted as it was in FIG. 5A on the right-hand side. On the left-hand side is the Optical Fiber 610 disposed within the U-Groove, not identified for clarity, wherein a first PWB has been formed between the Optical Fiber 610 and Optical Waveguide 640 comprising a first PWB Core 620 formed from PWB Resin 1 650 and a first PWB Cladding 630 formed from PWB Resin 2 660. Optionally, the first PWB may be formed solely from PWB Resin 1 650 if it is air clad or from multiple core materials and/or multiple cladding materials.

Also depicted is a second PWB which has been formed between the Optical Waveguide 640 and ISD 5010 comprising a second PWB Core 625 formed from PWB Resin 1 650 and a second PWB Cladding 635 formed from PWB Resin 2 660. Optionally, the second PWB may be formed solely from PWB Resin 1 650 if it is air clad or from multiple core materials and/or multiple cladding materials. Within other embodiments of the invention the core and/or cladding materials of the first PWB may be different to those employed for the second PWB based upon the requirements of the Optical Fiber 610, Waveguide 640 and ISD 5010.

It would be evident that the optical design approach depicted in FIG. 6A with an ISD with thin film active element may also be applied to an ISD with a thin film passive element as depicted in first to third images 300A to 300C respectively in FIG. 3.

Now referring to FIG. 6B there is depicted schematic of an IPSC showing the optical fiber and ISD sections according to an embodiment of the invention with an active ISD die according to FIG. 4 and dual PWB sections. The active ISD die according to fourth and fifth Images 400D and 400E in FIG. 4.

Accordingly, referring to FIG. 6B there is depicted a Plan 600C along section Z-Z and Cross-Section 600D along section X-X of an IPSC showing the optical fiber, PWB and ISD sections. Accordingly, the ISD 5030 is depicted as it was in FIG. 5B on the right-hand side. On the left-hand side is the Optical Fiber 610 disposed within the U-Groove, not identified for clarity, wherein a first PWB has been formed between the Optical Fiber 610 and Optical Waveguide 640 comprising a first PWB Core 620 formed from PWB Resin 1 650 and a first PWB Cladding 630 formed from PWB Resin 2 660. Optionally, the first PWB may be formed solely from PWB Resin 1 650 if it is air clad or from multiple core materials and/or multiple cladding materials.

Also depicted is a second PWB which has been formed between the Optical Waveguide 640 and ISD 5030 comprising a second PWB Core 625 formed from PWB Resin 1 650 and a second PWB Cladding 635 formed from PWB Resin 2 660. Optionally, the second PWB may be formed solely from PWB Resin 1 650 if it is air clad or from multiple core materials and/or multiple cladding materials. Within other embodiments of the invention the core and/or cladding materials of the first PWB may be different to those employed for the second PWB based upon the requirements of the Optical Fiber 610, Waveguide 640 and ISD 5030.

It would be evident that the optical design approach depicted in FIG. 6B with an ISD with an active element may also be applied to an ISD with a passive element as depicted in fourth and fifth Images 300D and 300E respectively in FIG. 3.

As depicted in FIGS. 6A and 6B the ISD 5010 and ISD 5030 are coupled to a single optical waveguide although it would be evident that an input and/or an output side may both contain a single optical waveguide and/or multiple optical waveguides disposed across the substrate. As depicted in FIGS. 6A and 6B the ISD 5010 and ISD 5030 are coupled to a single optical waveguide vertically although it would be evident that the input and/or the output side may contain multiple optical waveguide layers disposed vertically with respect to the substrate in other embodiments of the invention.

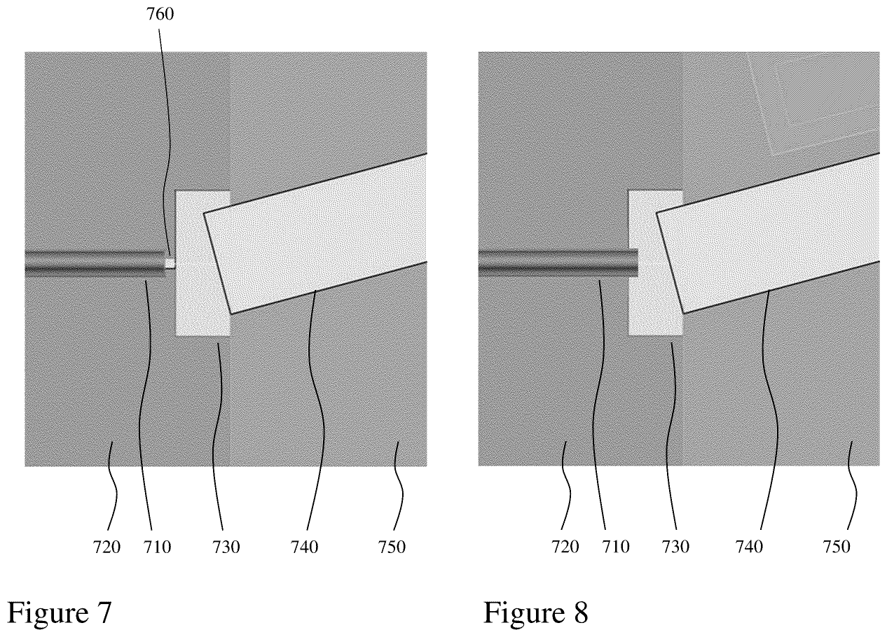

Referring to FIGS. 7 and 8 there are depicted exemplary conceptualizations an optical interface between an optical waveguide and an optical component according to embodiments of the invention. Referring initially to FIG. 7 there is depicted a schematic of a micro-machined silicon block (MSB) 720 and ISD assembly absent a common carrier beneath prior to the formation of the PWB. Within the embodiments of the invention described and depicted above in respect of FIGS. 1 to 6B the optical component has been described as being directed mounted to a substrate (e.g., a silicon substrate within which are fabricated optical waveguides) or indirectly mounted to the substrate via an ISD. However, in FIG. 7 the Optical Component 740 upon an ISD is mounted to a carrier to which the substrate comprising the Optical Waveguide 710 is also mounted such that there is no intermediate substrate between the Optical Component 740/ISD Carrier 750 and the carrier to which the MSB 720 is also mounted.

The Optical Waveguide 710 may for example be an optical fiber within a U-Groove such that the MSB 720 is simply a micro-machined silicon element. However, the Optical Waveguide 710 may be integrated upon the MSB 720 such that the MSB 720 is a micro-machined silicon element with integrated optical waveguides, and optionally integrated CMOS electronics. The Optical Waveguide 710 on the MSB 720 is aligned with an optical axis of the Optical Element 740, which is mounted to a ISD Carrier 750 such that the Optical Element 740 and ISD Carrier 750 forming the ISD is aligned in the desired position. However, exploiting a PWB interconnection relaxes this requirement as misalignments in the optical axes can be absorbed within the PWB interconnection. The end of the MSB 720 having a Pool 730 for containing the liquid for forming the PWB to interconnect the Optical Fiber 710 to the Optical Component 740. The ISD Carrier 750 and MSB 720 being mounted to a common carrier (not depicted for clarity). This interface region between the ISD Carrier 750 and MSB 720 forming the Pool 730 is depicted in more detail in second Image 700B in FIG. 7.

When the Optical Waveguide 710 is an optical fiber in a U-groove then the special shape of the End 760 (edge) of the U-Groove, a short region of reduced width relative to the U-groove provides for placement of the optical fiber by butting the facet of the optical fiber to the End 760 with a predetermined “x” displacement from the edge of the Pool 730 therein provided well defined positioning of the optical fiber core. Within FIG. 7 the Optical Component 740 is depicted with its facet overhanging the edge of the ISD Carrier 750 such that the facet of the Optical Component 740 projects into the Pool 730.

Within another embodiment of the invention the MSB 720 and ISD Carrier 750 are the same carrier wherein either the design of the U-Groove is modified in order to raise the core of the Optical Fiber 710 into axial alignment with the Optical Component 740 or the region upon which the Optical Component 740 is assembled is etched to lower the Optical Component 740 relative to the ISD Carrier 750.

Referring to FIG. 8 there is depicted a schematic of a variant of the design methodology depicted in FIG. 7. Accordingly, the same configuration of micro-machined silicon block (MSB) 720 and ISD Carrier 750 assembly absent the common carrier beneath prior to the formation of the PWB are depicted together with the Optical Waveguide 710, Pool 730, and Optical Component 740. However, in contrast to FIG. 7, the Optical Waveguide 710 now projects into the Pool 730. Whilst this provides increased access to the facet of the Optical Waveguide 710 then if the Optical Waveguide 710 is an optical fiber it does result in reduced positional accuracy in that facet and accordingly the implementation of the PWB between the Optical Fiber 710 and Optical Component 740 is subject to increased variation between devices or between elements of the same device if multiple optical elements were upon the device being packaged as a single component. A similar issue arises with the Optical Waveguide 710 defined through photolithography etc. upon the MSB 720 as the relative separation of the facet of the Optical Component 740 and the Optical Waveguide 710 now includes the tolerance of forming the MSB 720 as a discrete element from a wafer, e.g., by dicing.

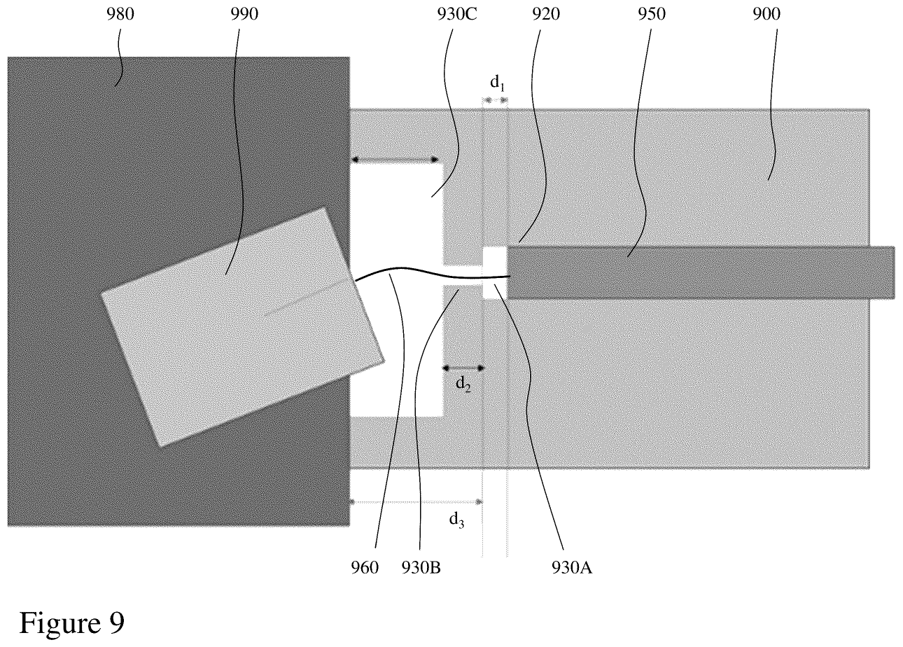

Referring to FIG. 9 there is depicted a schematic of a mechanical structure supporting the formation of a photonic wire bond (PWB) between an optical waveguide formed upon a substrate and a facet of an optical element mounted formed upon a carrier according to an embodiment of the invention. FIG. 9 depicting a variant design of the pools to that depicted in FIG. 7. Accordingly, as depicted an Optical Waveguide 950 is integrated onto, or mounted within a U-Groove formed within, a MSB 900 (e.g., silicon). The Optical Waveguide 950 End-Facet 920 defines part of a pool, this being defined by a first Pool Section 930A which begins where the interface between the first Pool Section 930A comprises End-Facet 920.

The first Pool Section 930A transitions to a second Pool Section 930B and therein to a third Pool Section 930C. Each of the first Pool Section 930A, second Pool Section 930B, and third Pool Section 930C being formed within the MSB 900. The lengths of these sections of the pool being d₁, d₂, and d₃ respectively. An Optical Element 990 mounted upon a ISD Carrier 980 which is positioned to abut the end of the third Pool Section 930C. Accordingly, the Optical Element 990 and ISD Carrier 980 form a fourth wall of the pool whereas the sidewalls of the first Pool Section 930A, second Pool Section 930B, and third Pool Section 930C form another pair of sidewalls of the pool whilst the end of the Optical Fiber 950 forms the final sidewall of the pool within which the liquid(s) are disposed for the formation of the PWB Core 960 and/or PWB cladding.

The PWB provides an optical “bridge” between the Optical Waveguide 950 and the facet of the Optical Element 990 which transitions from a first mode field diameter (MFD) of the Optical Fiber 950 to a second MFD of the optical facet of the Optical Element 990. The dimensions of the first Pool Section 930A, second Pool Section 930B, and third Pool Section 930C are established in dependence upon several factors, including the dimensions of the two optical elements being interconnected, providing a clear field of view for the optical imaging system used to acquire the locations for the ends of the PWB, and providing clear access for the illumination system employed to form the PWB core and/or cladding. The dimensions may also depend upon whether one or both ends are coupling to angled interfaces etc. In other embodiments of the invention these aspects may be modified if the MSB 900 allows optical imaging system and the illumination system to access different sides of the MSB 900.

Where the optical imaging system and illumination system are optically based then the MSB 900 must be transparent or have low attenuation in the applicable wavelength range(s). However, in other instances with non-optical illumination for forming the PWB this requirement may be modified such that the MSB 900 is transparent or has low attenuation for the non-optical illumination system for forming the PWB whereas the optical imaging system does not view through the MSB 900.

Within FIG. 9 the dimensions of second Pool Section 930B are smaller, at least laterally, than the first Pool Section 930A and second Pool Section 930C as the optical imaging system does not require access to these regions. Once the locations of the ends of the PWB are defined then the path of the PWB is defined by a processing system that then controls the illumination system forming the PWB and/or a positioning system upon which the CoC 980 and MSB 900 are mounted via a sub-carrier, package, etc. Accordingly, within other embodiments of the invention the pool may comprise a single section, two sections, four sections or more. Further, the lateral width and depth of each section may vary rather than being constant.

Referring to FIGS. 7 to 9 respectively the Optical Component 740 and the Optical Element 990 may be thin film passive element, such as Thin Film Passive Element 330 in FIG. 3, a passive element, such as Passive Element 340 in FIG. 3, a thin film active element, such as Thin Film Active Element 460 in FIG. 4, an active element, such as Active Element 470 in FIG. 4, or a combination thereof. Similarly, with respect to FIGS. 1B, 1C, and 2D the Component 190 may be a thin film passive element, such as Thin Film Passive Element 330 in FIG. 3, a passive element, such as Passive Element 340 in FIG. 3, a thin film active element, such as Thin Film Active Element 460 in FIG. 4, an active element, such as Active Element 470 in FIG. 4, or a combination thereof.

Within embodiments of the invention where multiple elements are employed to form the Component 190, Optical Component 740, and the Optical Element 990 etc. then it would be evident that within these embodiments of the invention these multiple elements may be monolithically integrated or they may be optically interconnected using PWBs such that the ISD Carrier is micro-machined to provide the pools etc. as described above with respect to embodiments of the invention. Accordingly, the embodiments of the invention described and depicted above can be employed to provide an optical sub-circuit which is then assembled into a larger optical circuit using the same techniques according to embodiments of the invention.

Within embodiments of the invention described above a PWB is described as being formed by directly writing at least a core of the PWB by a two-photon absorption triggered process within a liquid photosensitive material to polymerize the material. However, within other embodiments of the invention the triggering of a phase change or chemical process to form a PWB may exploit, for example, infrared (IR) radiation, visible radiation, ultraviolet (UV) radiation, microwave radiation, radio frequency (RF) radiation, X-ray radiation, electron beam radiation, ion beam radiation, an ultrasonic signal, an acoustic signal and a hypersonic signal.

Within other embodiments of the invention an optical sub-element of an optical element and/or sub-elements of the optical element which is being assembled with other optical waveguides upon a substrate to which the optical element directly attached, indirectly attached via an ISD or connected to via a common carrier, may be formed or partially formed using one or more manufacturing processes to trigger a chemical reaction or phase change within a material. Such processes may employ, for example, photon absorption, multi-photon absorption IR radiation, visible radiation, UV radiation, microwave radiation, RF radiation, X-ray radiation, electron beam radiation, ion beam radiation, an ultrasonic signal, an acoustic signal and a hypersonic signal.

Within other embodiments of the invention an optical sub-element of an optical element and/or sub-elements of the optical element which is being assembled with other optical waveguides upon a substrate to which the optical element directly attached, indirectly attached via an ISD or connected to via a common carrier, may be formed or partially formed using one or more manufacturing processes to induce localized increases or reductions in the material refractive index discretely or in combination with one or other processes to form the optical element. For example, damage can be induced such that the induction of damage selectively increases or decreases the refractive index of the material in the damaged region in dependence upon the degree of damage induced. In some embodiments multiple damage profiles may be employed to create the desired final refractive index profile. In embodiments of the invention an aspect of the induction of damage may be employed to tune the location of the induced damage such that, for example, damage reducing a refractive index is induced at a predetermined depth below the surface of the material being damaged. Such damage may be induced from atomic bombardment, e.g., proton bombardment, electron bombardment, ion bombardment, IR radiation, visible radiation, UV radiation, microwave radiation, RF radiation, X-ray radiation, electron beam radiation, ion beam radiation, an ultrasonic signal, an acoustic signal and a hypersonic signal. In some embodiments of the invention this induced damage may be the formation of vacancies within the lattice of the material.

Accordingly, within embodiments of the invention one or more portions of an optical component may be established through direct writing of the optical component using one or more stages of direct writing. Within other embodiments of the invention one or more portions of an optical component, which the inventors refer to as Direct Write Optical Components, may be established through direct etching, patterning, doping or deposition using one or more states of etching or patterning with a direct writing of the region being etched or patterned. The direct write etching, patterning, doping, deposition may be induced through atomic bombardment, proton bombardment, electron bombardment, ion bombardment, IR radiation, visible radiation, UV radiation, microwave radiation, RF radiation, X-ray radiation, electron beam radiation, ion beam radiation, an ultrasonic signal, an acoustic signal and a hypersonic signal.

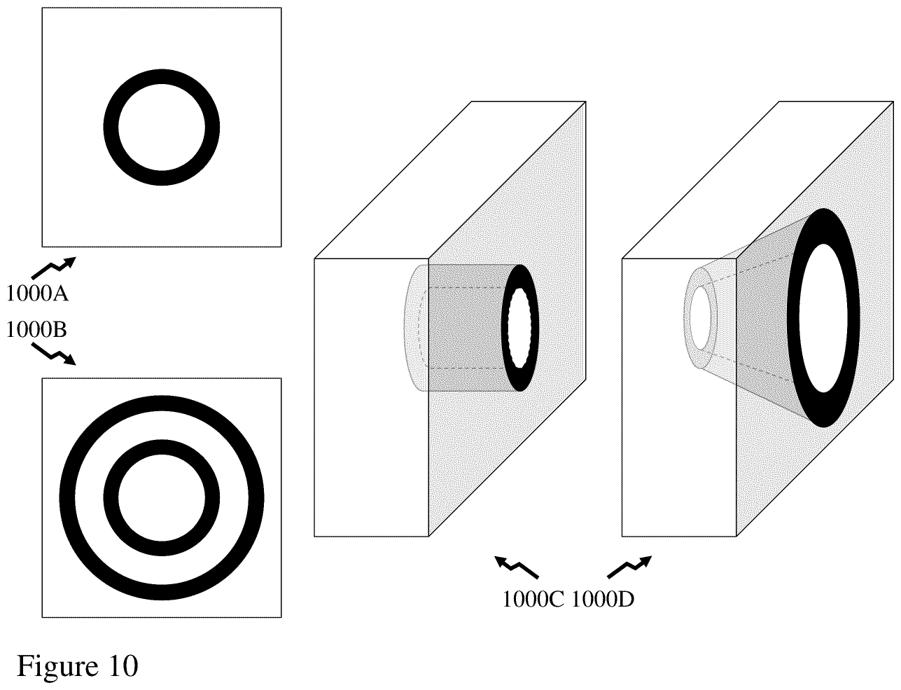

For example, referring to FIG. 10 there are depicted first to fourth Direct Write Optical Components 1000A to 1000D respectively. As depicted first Direct Write Optical Component 1000A comprises a material with a single ring of different refractive index, e.g., lower refractive index, to form an optical waveguiding region in the central portion of the first Direct Write Optical Component 1000A.

In contrast second Direct Write Optical Component 1000B comprises a material with a multiple rings of different refractive index, e.g., lower refractive index, to form an optical waveguiding region in the central portion of the second Direct Write Optical Component 1000B. Alternatively, the central circular region and the annular ring between the rings of different refractive index may guide optical signals or within another embodiment of the invention the annular rings of different refractive index form a pair of annular waveguides.

The profile of these regions of different refractive index may be constant through a thickness (along the optical axis) of the optical component such as depicted within third Direct Write Optical Component 1000C. Alternatively, as depicted with fourth Direct Write Optical Component 1000D the regions of different refractive index may vary in geometry through the thickness (along the optical axis) of the component.

It would be evident to one of the skill in the art that the first to fourth Direct Write Optical Components 1000A to 1000D respectively may also represent examples of PWBs to couple to/from an optical element. Whilst first to fourth Direct Write Optical Components 1000A to 1000D respectively depict a single structure it would be evident that a structure may be replicated across the width of the optical component and/or the height of the optical component to form one-dimensional or two-dimensional arrays of elements within the optical component.

Whilst the structures depicted in first to fourth Direct Write Optical Components 1000A to 1000D respectively are circularly symmetric it would be evident that within other embodiments of the invention the structures may be asymmetric, be symmetric with respect to an axis (e.g., an axis perpendicular to optical propagation axis), be symmetric with respect to two axes (e.g., two mutually perpendicular axes which are also perpendicular to an optical propagation axis), have a regular cross-section, have an irregular cross-section, have constant cross-section along the optical propagation axis, have a variable cross-section along the optical propagation axis, have a cross-section defined by a regular polygon, have a cross-section defined by an irregular polygon, have a cross-section defined by a mathematical function, or have a random cross-section.

Within embodiments of the invention a Direct Write Optical Component, such as first to fourth Direct Write Optical Components 1000A to 1000D respectively may be employed in conjunction with embodiments of the invention described and depicted above in respect of FIGS. 1A to 9 such that the Direct Write Optical Component is coupled to or from an optical waveguide through direct coupling or through PWBs. Within other embodiments of the invention the Direct Write Optical Component may be coupled through micro-lenses, ball lenses, directly fabricated lenses etc.

Whilst embodiments of the invention are described and depicted with respect to photonic circuits, such as integrated photonics silicon chips (IPSCs) or integrated photonic circuits (IPCs), it would be evident that embodiments of the invention, e.g. Direct Write Optical Components, may be employed discretely with other optical devices such as light emitting diodes (LEDs), laser diodes (LDs), photodetectors (PDs), and avalanche photodetectors (APDs) for example.

Accordingly, optical structures can be written into a material which forms the substrate or body of the optical element within which the optical structures are written. These optical structures may include a thin film passive element, such as Thin Film Passive Element 330 in FIG. 3, a passive element, such as Passive Element 340 in FIG. 3, a thin film active element, such as Thin Film Active Element 460 in FIG. 4, an active element, such as Active Element 470 in FIG. 4, or a combination thereof according to the material properties of the material which forms the substrate or body of the optical element discretely or in combination with a direct write process according to embodiments of the invention. For example, an optical waveguide can be defined within a substrate, e.g. by ion implantation (e.g. H+) to generate defects that reduce the refractive index, where regions of the optical waveguide are then doped through a second implantation process, e.g. erbium and/or ytterbium implantation to generate an active region within the passive region.

Accordingly, it would be evident that optical components formed within substrates that are incompatible with specific functionalities etc. may be augmented by the addition of an optical component formed from another material that is either directly inserted into a cavity, e.g. Component 190, inserted into a cavity as part of an ISD, e.g. ISD 5010 in FIGS. 5A and 6A respectively or ISD 5030 in FIGS. 5B and 6B respectively, or upon a common carrier such as Optical Components 740 and 990 in FIGS. 7-9 respectively.

Optionally, optical components formed within the substrates may be processed through a separate processing line before being combined or they may be processed in-situ during the processing. For example, periodically poled lithium niobate may be formed in a laminated sheet through epitaxial lift-off, disposed upon a silicon carrier and then a waveguide directly written into the lithium niobate. This waveguide may then be directly coupled to the optical waveguides formed within the silicon carrier, see for example FIGS. 5A and 5B respectively, or coupled via one or more PWBs, see for example FIGS. 6A and 6B respectively.

Within another embodiment of the invention a region of the substrate may be directly written to reduce or remove a characteristic of the substrate. For example, if the substrate enables a phase shift or a polarization rotation of light passing through it then it may be a function of the circuit that two paths through the optical circuit should have comparable performance but one path is subjected to Faraday rotation whilst the other is not. Accordingly, a material supporting phase shift or a polarization rotation is provided between two pairs of waveguides. Each pair of waveguides couples directly or via PWBs to an optical waveguide formed within the material supporting Faraday rotation, for example, through proton exchange or ion implantation. However, one waveguide in the material supporting phase shift or a polarization rotation is then subjected to a further implantation that impacts the ability of the material to support phase shift or a polarization rotation but does not impact the optical waveguide.

Alternatively, a characteristic of the material may be selectively increased or reduced post-component manufacture in order to tune the component by adjusting the direct writing of an element within the component. For example, a waveguide may be selectively written or reduced in refractive index to tune its loss, chromatic dispersion, polarisation mode dispersion, polarisation mode dependent loss, etc.

Within some embodiments of the invention this adjustment in a property of the waveguide to a specific form of radiation may allow such as waveguide to become a sensor for said radiation allowing the “dose” or “dose rate” of the radiation to be established through an optical technique.

Within other embodiments of the invention such direct writing and hybrid integration techniques as described above allow for a material incompatible with conventional semiconductor processing techniques to be employed such as diamond, for example.

Further, the techniques described and depicted allow an optical element formed within a first material technology to be packaged and coupled to one or more optical fibers through a substrate formed within a second material technology. For example, a III-V semiconductor amplifier may be packaged upon a polymer, ceramic, or metallic carrier formed, for example, using a Lithographie, Galvanoformung, Abformung (LIGA, lithography, electroplating, and molding) process directly or molded/stamped using a template formed by such techniques.

Specific non-limiting examples of materials and/or waveguides employed in these optical components such as Thin Film Passive Element 330 in FIG. 3, a passive element, such as Passive Element 340 in FIG. 3, a thin film active element, such as Thin Film Active Element 460 in FIG. 4, an active element, such as Active Element 470 in FIG. 4, or a combination thereof may include, but not be limited to:
diamond with nitrogen vacancies or other defect leading to one or more quantum spectroscopic effects;
silicon carbide with silicon vacancies, nitrogen vacancies, a combination of vacancies or other defect leading to one or more quantum spectroscopic effects;
lithium niobate (LiNbO3), periodically poled lithium niobate or dual periodically poled lithium niobate;
lithium tantalate (LiTaO3), periodically poled lithium tantalate or dual periodically poled lithium tantalate;
lithium iodate (LiIO3), potassium niobate (KNbO3), monopotassium phosphate (KH2PO4, KDP), lithium triborate (LBO), β-barium borate (BBO), gallium selenide (GaSe), potassium titanyl phosphate (KTP), or ammonium dihydrogen phosphate (ADP);
lead zirconium titanate (PbZr/TiO3), barium titanate (BaTiO3), lead titanate (PbTiO3), aluminium nitride (AlN); or zinc oxide for piezoelectric effect;
undoped GaAs for magneto-optic effect;
arsenic trisulfide (As2S3), tellurium dioxide (TeO2), tellurite glasses, lead silicate (PbO:xSiO2), germanium arsenic sulphide (Ge55As12S33), mercury chloride (Hg2Cl2), lead (II) bromide (PbBr2) for acousto-optic based optical active elements such as tunable filters, deflectors, spectrometers, etc.

### Magnetless Faraday Rotator

As noted above various materials and/or waveguides can be employed to form optical components including materials that exhibit the magneto-effect and/or allow a path within a device to exploit Faraday rotation. A Faraday rotator exploits the Faraday effect, a magneto-optic effect, to implement non-reciprocal devices such as magneto-optic isolators, circulators and switches. Faraday rotation is an example of non-reciprocal optical propagation. However, the integration of these non-reciprocal magneto-optic elements poses design and manufacturing challenges of which two are the requirement of providing a bias magnetic field and their integration in a waveguide format.

As the magneto-optic effect involves transmission of light through a material when a longitudinal static magnetic field is present then prior art devices require that permanent magnets or active electromagnets form part of the system to provide this static magnetic field. These have drawbacks such as increased power consumption, heating, mechanical instability, costs related to their alignment, bulkiness of the device and the potential to affect other nearby components.

Integration into a waveguide format presents challenges to exploit these within photonic integrated circuits as a low-loss waveguide is required without the polarization mode birefringence induced in asymmetric waveguide geometries whilst retaining full magneto-optic functionality.

Accordingly, as outlined below the inventors have established a magnetless Faraday rotator waveguide. Further, by exploiting a direct write ultrafast-laser processing approach initial prototype magnetless Faraday rotator waveguides exhibit <0.15 dB insertion loss with a figure of merit of up to 346° dB⁻¹. Whilst the device designs and device manufacturing processes described below exploit bismuth-doped iron garnet (BIG) to provide a magnetless-based Faraday rotator waveguide operating in a common telecommunications wavelength band it would be evident that other materials may be employed targeted to other wavelength ranges either within the telecommunications bands or others for applications within optical sensors, transmitters, receivers, etc. without departing from the scope of the invention.

Within the prototype device described below the magnetless Faraday rotator waveguide is disposed between a pair of thin-sheet polarizers, e.g. Polarcor™ UltraThin™ polarizers, butt-coupled with two 1550 nm standard singlemode optical fibers. However, it would be evident that other thin-film polarizers may be employed. Further, optical waveguide polarizers may be implemented either side of the magnetless Faraday rotator waveguide within other embodiments of the invention.

The prototype magnetless sub-millimeter-size optical isolator achieves >25 dB isolation ratio (limited by the polarizers) with <1.5 dB insertion loss across the entire infrared optical C-band. Further, the low-cost, chemical-free, and maskless patterning technology minimizes the usage of raw materials, diminishes the environmental impact, and enables low-loss miniaturized nonreciprocal photonic devices to be implemented.

### Magnetless Faraday Rotator Waveguide Fabrication

In order to fabricate a low-loss waveguide without polarization mode birefringence induced in asymmetric geometries, whilst retaining full magneto-optic functionality, a homogenous cylindrical waveguide within an embodiment of the invention is fabricated within the material. Within an embodiment of the invention the inventors achieve this by using a femtosecond (fs) laser emitting at a wavelength within the transparent window of the material. Femtosecond lasers enable microscale processing of complex three-dimensional structures due to the nonlinear nature of the laser absorption that precisely confines structural changes to the focal volume. By appropriate adjustment of the optical system this focal volume can be disposed within the body of the material and translated within the material.

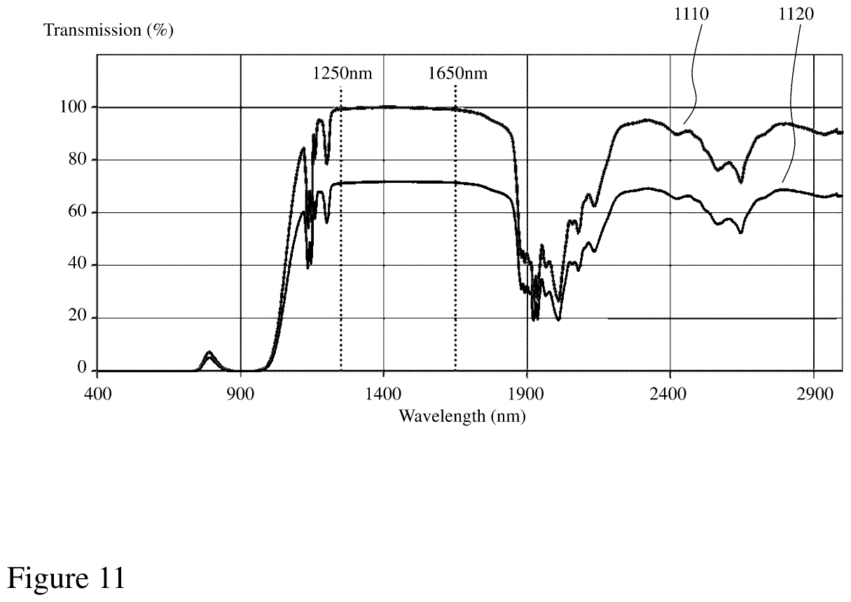

Referring to FIG. 11 there is depicted a plot of the transparency window of bismuth-doped iron garnet (BIG) with first Curve 1110. Second Curve 1120 depicts the transmission of BIG including the Fresnel reflections to air. As evident in FIG. 1 the transparency window is relatively narrow in the infrared, i.e., from about 1250 nm to 1650 nm, which can complicate laser writing and characterization of three-dimensional (3D) waveguides. Most femtosecond laser writing systems are based on titanium-sapphire lasers (Ti:Al2O3 lasers) that emit red or near-infrared light from 650 nm to 1100 nm or Yb-doped fiber amplifiers which emit at around 1025 nm to 1075 nm. Such femtosecond laser systems and their harmonic generations at lower wavelengths are linearly absorbed by the BIG and therefore cannot be used to inscribe waveguides deep inside the material.

Accordingly, within the experiments described and presented below the inventors employ an optical parametric amplifier (OPA) which can transform high-energy 800 nm laser pulses to a wavelength from 189 nm to 4500 nm. Within the prior art, for other applications, it was reported that high quality waveguides were easier to laser inscribe using shorter wavelengths within the transparent window of a material as a result of higher efficiency of the multiphoton absorption. Accordingly, the inventors employ a wavelength of 1300 nm within the processes and devices described below. The inventors also demonstrated successful laser writing tests using 1550 nm output from the OPA but laser-induced material modifications without damage or ablation were more difficult to obtain, especially near the surface of the material.

A Type 1 modification (also referred to as a laser-induced smooth refractive index change without damage) is directly induced by the laser inscribed track. However, the inventors established several problems that had to be overcome in order to inscribe, for the first time to the inventor's knowledge, a three-dimensional (3D) waveguide in bismuth-doped iron garnet (BIG). Considering laser writing, BIG is very similar to silicon, having both a narrow band gap (opaque below ˜1200 nm) and high refractive index. For comparison, in the last 20 years, attempts to modify the bulk of silicon with ultrashort laser pulses typically failed and only a few successes with high propagation losses have been reported very recently. Moreover, the Faraday effect in BIG complicates the task. The 45° faraday rotation produced by a BIG thick film (480 μm) operates perpendicular to the film. To rotate the polarization 1550 nm light coming from an optical fiber by 45°, a 480 μm long waveguide must therefore be inscribed perpendicular to the film.

The 480 μm thickness of the BIG was established in dependence upon the magnitude of Faraday rotation (45°) and the operating wavelength (1550 nm). However, it would be evident that the techniques described with respect to embodiments of the invention may be applied to BIG substrates of different thicknesses and/or other substrates of different thicknesses.

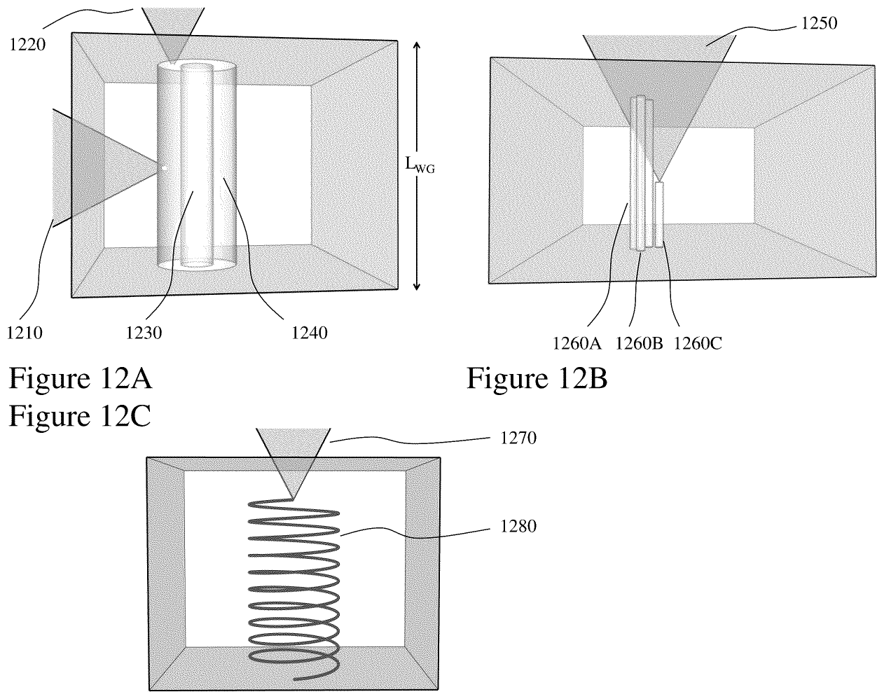

Establishing a focal volume within the BIG is severely limited by the working distance of the focusing objective or optical system establishing the focal volume. Accordingly, within the prior art optical waveguides a few millimeters or centimeters long are typically inscribed perpendicular to the laser beam, referred to as transverse writing, as depicted by Traverse Beam 1210 in FIG. 12A. Once written then the input and output facets of the optical waveguide are carefully cut (diced) and polished due to the bulk side effects when the beam is focalized.

Considering the geometry of the BIG film, then longitudinal writing, where the laser beam is parallel to the axis of the waveguide to be formed, see first Longitudinal Beam 1220 in FIG. 12A is the logical choice. Further, post processing of the facets should be avoided in order to maintain the length of BIG in order to maintain the required precise rotation of the polarization.

Within other embodiments of the invention a Transverse Beam 1210 and first Longitudinal Beam 1220 may be employed in conjunction with one another wherein the focal region formed by the overlapping of them exceeds a threshold to generate the required index change. Alternatively, two or more first Longitudinal Beams 1220 may be employed which are each off-axis where the focal region is formed by the overlapping off-axis first Longitudinal Beams 1220.

As the inventors observed that the Faraday effect was affected by the laser-induced modification, a depressed cladding waveguide (DCW) should be laser inscribed rather than the direct laser inscription of a waveguide core with a positive refractive index change in the laser written region. Accordingly, as depicted in FIG. 12A laser writing a DCW is established by laser writing the Waveguide Cladding 1240 such that the Waveguide Cladding 1240 has a lower refractive index than the intrinsic BIG material. Accordingly, the Waveguide Core 1230 is intrinsic BIG material, not affected by the laser writing.

Direct laser inscription of a waveguide core is based on a positive type I (smooth modification) refractive index change whilst a DCW is based on a negative type I (smooth modification) index change or type III damage based (i.e. induced damage by laser writing) index change. Within the application of the magnetless Faraday rotator optical waveguide a type III index change based waveguide produces waveguides with high propagation loss due to the waveguide interface roughness and affects the strength of the material. Accordingly, it is desirable for the Faraday rotator optical waveguides according to embodiments of the invention to avoid such type III index changes. Accordingly, the inventors performed single laser scan tests to achieve a smooth Type I negative refractive index change within BIG.

Referring to FIG. 12B there is depicted a writing methodology for a DCW optical waveguide wherein a second Longitudinal Beam 1250 is employed to generate multiple longitudinal regions of reduced refractive index, for example first to third Longitudinal Regions 1260A to 1260C respectively. Accordingly, with the appropriate placement of the second Longitudinal Beam 1250 when forming each longitudinal region of the multiple longitudinal regions the circular cladding of the DCW can be written around the unmodified core.

Within other embodiments of the invention a Transverse Beam 1210 and second Longitudinal Beam 1250 may be employed in conjunction with one another wherein the focal region formed by the overlapping of them exceeds a threshold to generate the required index change. Alternatively, two or more second Longitudinal Beams 1250 may be employed which are each off-axis where the focal region is formed by the overlapping off-axis second Longitudinal Beams 1250.

Referring to FIG. 12C there is depicted a writing methodology known as “helical writing” wherein a third Longitudinal Beam 1270 is employed and traverses a helical path to form the cladding of the DCW optical waveguide (not shown for clarity). Whilst a helical path could be written to form a core of an optical waveguide wherein positive refractive index changes are induced it would be evident that the helix would have to be very small, potentially smaller than the focal region of the third Longitudinal Beam 1270.

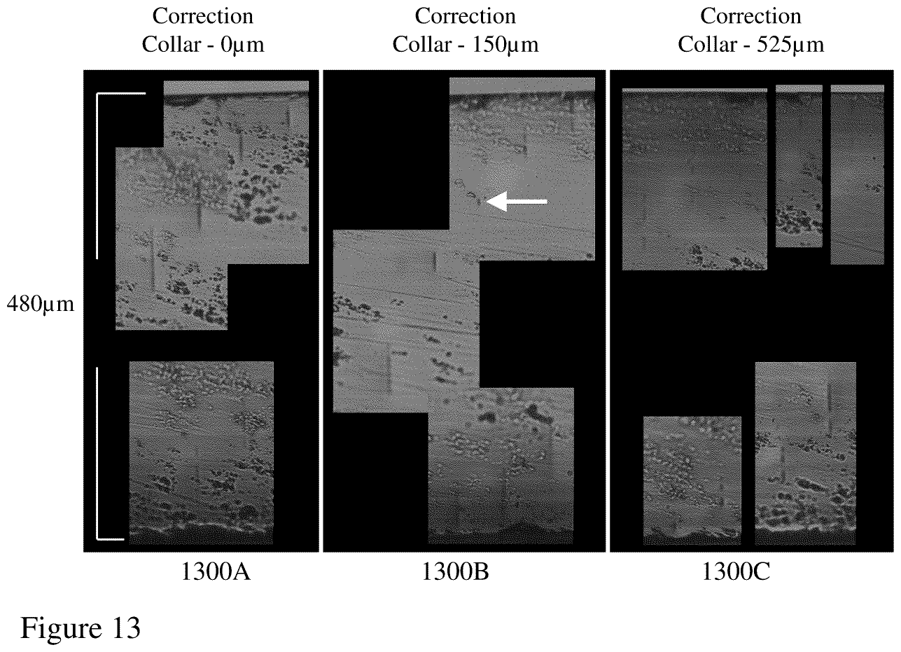

The inventors established that the type I laser-induced modification window within BIG is narrow and highly dependent upon the writing depth. In fact, the high refractive index of BIG (n=2.327 at 1310 nm) induces a strong spherical aberration within the laser beam which elongates the focal spot with depth. Within the experiments performed by the inventors the height of the focal spot can be from a few microns to about 70 μm as depicted in FIG. 13. As illustrated in FIG. 1300D, these elongated traces are cross sectional views of 2 mm long straight lines inscribed perpendicular to the image at different depths, at a scan speed of 0.5 mm/s and using a microscope objective lens (×100 magnification with 0.85 numerical aperture) with a correction collar for spherical aberration correction. These section views of the laser traces are those that will be moved into the material in order to form the cladding of the waveguide. A judicious choice of these laser spot shapes will make it possible to reduce the propagation losses of the waveguide.

Referring to FIG. 13 in first Image 1300A cross sectional views of laser traces with the correction collar set to 0 μm (no spherical aberration correction) are depicted. The trace at the top being the closest one to the surface it was possible to write without ablation. This being written with a laser power of 0.24 mW (pulse energy of 0.24 μJ at a repetition rate of 1 kHz). No material modification occurred using a slightly lower power and surface ablation occurred at slightly higher power. In order to inscribe a DCW, a multiscan technique, such as depicted in FIG. 12B, is required to fill the cladding with a negative refractive index change (Δn<0). Unfortunately, using an unaberrated laser focal spot, obtained at a specific depth corresponding approximately to the correction collar value, see the white arrow in second Image 1300B in FIG. 13, the multiscan technique only resulted in damaging the material since it requires a large number of laser scans to homogeneously fill the waveguide cladding. This being written with a correction collar position of 150 μm. Nevertheless, using this small unaberrated laser spot of a few microns in vertical size, it would take significant time to overlap the entire thickness of the BIG bulk (480 μm) and thus inscribe the waveguide.

Moreover, in this longitudinal writing geometry, vertically elongated laser spots are beneficial for lower waveguide propagation losses. Indeed, more circular laser spots as illustrated in Image 1300E are required to be much closer together to form a smooth guide interface. As illustrated in Image 1300F, even separated by only 1 μm, the 2.5 μm×5 μm laser spots still produce roughness while the 10 times more elongated (2.5 μm×50 μm) laser spots do not produce visible roughness when separated by 8 μm, as illustrated in Image 1300G. This roughness, which is the same as that at the core-cladding interface of the waveguide, is the main cause of the propagation losses in this type of laser-written waveguides.

Since small laser spots are not a practical option, the inventors trialed 11 different correction collar positions (from 0 μm to 750 μm) to inscribe at all depths (from 0 μm to 480 μm) inside the BIG bulk in order to obtain homogenously elongated laser spots through the entire thickness of the BIG bulk. First to third Images 1300A to 1300C being at correction collar positions of 0 μm, 150 μm and 525 μm, respectively. As depicted in third Image 1300C the best result obtained was with elongated laser spots through the entire bulk thickness using a correction collar of 525 μm. At correction collar positions above 525 μm these larger values resulted in weaker modification at the top surface and smaller values resulted in ablation at the bottom surface due to the small unaberrated laser spot at this depth being close to 480 μm.

Accordingly, it was evident to the inventors that there was room for further improvement in the laser writing process for forming the DCW. For example, the elongated spot in the middle of the BIG bulk using a correction collar at 0 μm (first Image 1300A in FIG. 13) has improved uniformity and the laser power could be slightly modified as a function of the depth. However, finding the best laser writing conditions at every depth, whilst possible, would require significant work and the automation of the variation of the correction collar and the power during the entire waveguide fabrication would lead to an increased complexity laser writing system.

Accordingly, the inventors established what they refer to as the “alternating spiral-helix laser writing technique.” For the longitudinal laser writing (see FIG. 12A), two laser scanning geometries have been used in the literature, multiscan of longitudinal lines (see FIG. 12B) and helical writing (see FIG. 12C). Using these two scanning geometries, the inventors only obtained high propagation losses (>2 dB/cm) in BIG, which are similar to the losses obtained in other materials within the prior art.

In order to obtain low optical propagation losses, the laser written cladding of the DCW should be uniform and the cladding should be sufficient, through combination of index reduction and “thick” enough (i.e. wide enough) to confine the optical mode. Using the multiscan technique, illustrated in FIG. 12B, the focalized laser beam is affected by the previously written lines. The more lines written, the more the focused laser is scattered and the focal spot is modified, especially when multiple cladding layers are written which may be required or beneficial in device designs. Within the prior art only one cladding layer have been previously reported using the longitudinal writing technique. For this same multiscan technique using transverse laser writing (see Traverse Beam 1210 in FIG. 12A), the lower loss waveguides reported in the prior art employed multiple cladding layers. Moreover, each time a line begins or ends it induces a non-uniform region. The scan speed can be increased or decreased, and if the speed is zero, a larger laser spot of accumulated energy is formed within the material. Therefore, a constant laser scan speed should be used during the full process of the waveguide fabrication.

The helical writing process, depicted in FIG. 12C, partially solves the problem as there are one beginning and one end of the laser writing process for each helix and the scanning speed is constant during the writing of the helix along the length of the waveguide. However, the focalized laser beam is inevitably affected by a previously written helix.

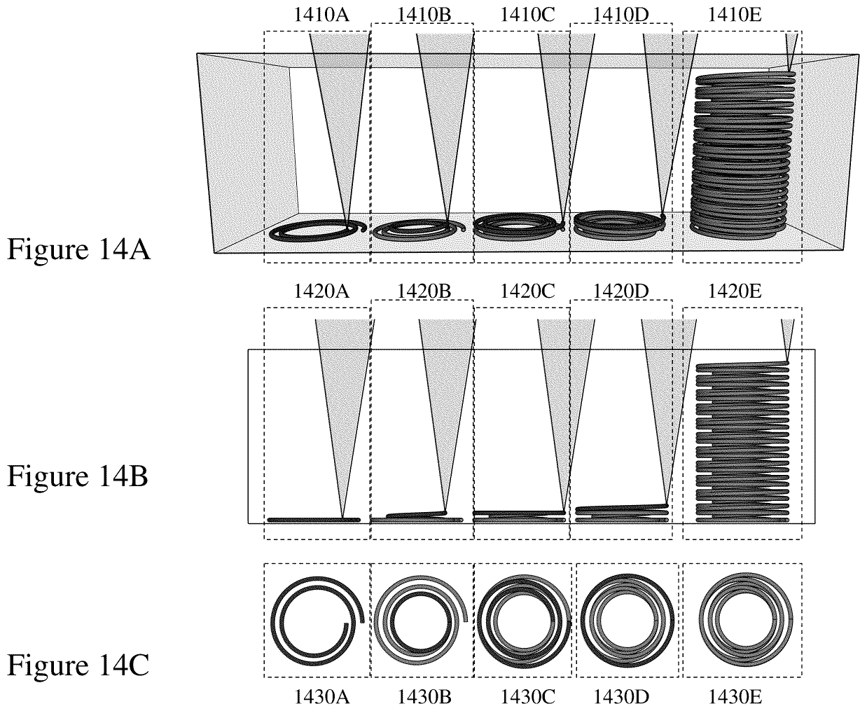

In order to address these issues the inventors established what they refer to as the alternating spiral-helix laser writing technique. Referring to FIG. 14A there are depicted first to fifth three-dimensional (3D) perspective views (3DPVs) 1410A to 1410E respectively of writing into a material using a laser writing system that employs the spiral-helix laser writing technique according to an embodiment of the invention. In FIGS. 14B and 14C there are depicted first to fifth lateral views (LVs) 1420A to 1420E and first to fifth plan views (PVs) 1430A to 1430E respectively for the spiral-helix laser writing technique according to an embodiment of the invention depicted in FIG. 14A at the same stages.

Within the following description the process is described as being written from the bottom of a sample to the top of the sample. However, the process may be reversed from the top of the sample to the bottom of the sample. Alternatively, if sufficient registration to features within the sample can be made then optionally a pair of writing sequences may be employed writing from each surface to a predetermined depth or from the predetermined depth to the surface. Optionally, the waveguide may be written in multiple sequences each within a predetermined portion of the sample.

Within the following description the spiral is described as being written from an outside of the region being written to an inside of the region (spiral in). However, it would be evident that the spiral may alternatively be written from the inside of the region to the outside of the region (spiral out).

In a first step, as depicted by first 3DPV 1410A, first LV 1420A and first PV 1430A, an initial spiral is written in a spiral-in process such that an initial spiral is inscribed at the bottom of the sample.

In a second step, as depicted by second 3DPV 1410B, second LV 1420B and second PV 1430B, an initial inside helix (first helix) is written which is inscribed from the bottom (first layer) to a vertical position associated with a second layer.

In a third step, as depicted in third 3DPV 1410C, third LV 1420C and third PV 1430C, a second spiral t is written on the second layer but from the inside of the region to the outside of the region in a spiral-out process.

In a fourth step, as depicted in fourth 3DPV 1410D, fourth LV 1420D and fourth PV 1430D, an outside helix (second helix) is written in a spiral out process wherein the second helix is inscribed from the second layer to a next layer up (third layer).

Within an embodiment of the invention the third and fourth steps are repeated such that the spirals and helices are written sequentially in layers as evident in fifth 3DPV 1410E, fifth LV 1420E and fifth PV 1430E such that the overall written region comprises a series of alternating spirals and helices.

Within another embodiment of the invention the first to fourth steps are repeated such that the spirals and helices are written sequentially in layers as evident in fifth 3DPV 1410E, fifth LV 1420E and fifth PV 1430E such that the overall written region comprises a repeating series of spiral in spiral, inside helix, spiral out spiral and outside helix to sequentially construct the overall written region.

Within FIGS. 14A to 14C a single written spiral is described with respect to first and third steps respectively. However, within embodiments of the invention multiple spirals may be written for each of the spiral in/spiral out that are nested with respect to each other so that a region is written across the substrate at that layer. Similarly, within FIGS. 14A to 14C a single written helix is described with respect to third and fourth steps respectively. However, within embodiments of the invention multiple spirals may be written for each of the inside helix/outside helix that are nested with respect to each other so that a region is written across the substrate between a current layer and the next sequential layer.

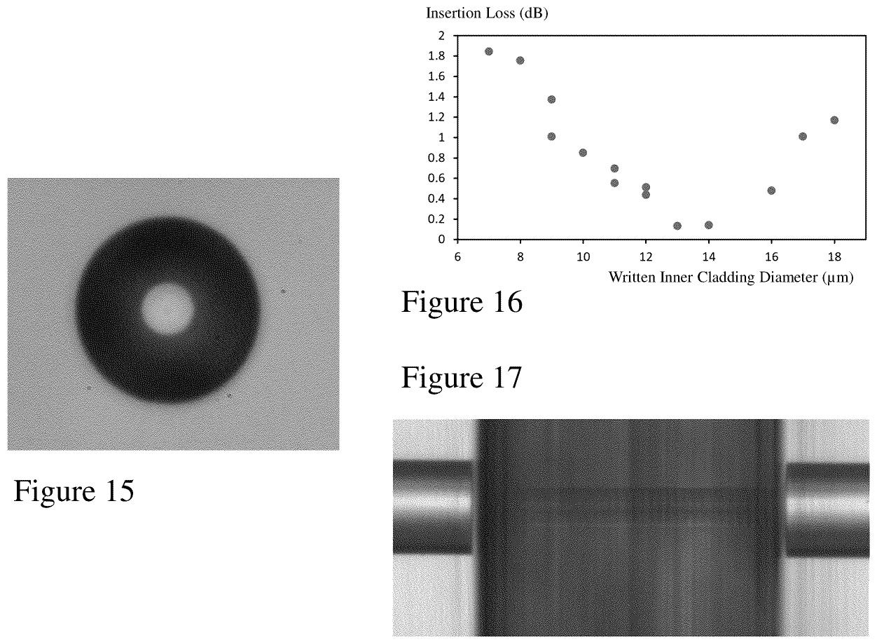

By starting and ending the laser writing scan on the outer face of the cladding, no non-uniformity is formed at the interface of the waveguide core. A cross section view of such a waveguide, inscribed in BIG, is shown in FIG. 15 demonstrating the high uniformity of the inscribed cladding. Using this new alternating spiral-helix laser writing technique the inventors have demonstrated optical waveguides with insertion losses below 1 dB and these were employed within the following description.

In order to establish the optical waveguides within BIG several writing parameters were optimized to achieve the high-quality Faraday rotator waveguides, including, laser scan speed, horizontal laser track spacing, vertical laser tracks spacing, laser pulse energy, inner cladding diameter and outer cladding diameter. In order to match the optical mode profile of commercial singlemode optical fiber waveguides and to prevent the evanescent wave from interacting with the cladding (the laser-modified cladding affects the Faraday effect), a high refractive index change Δn is required. This can be obtained with a lower laser scan speed, smaller horizontal and vertical laser tracks spacing and higher laser pulse energy. It would be evident that the optical mode profile of the Faraday rotator waveguide may be tailored to silica waveguides, silicon oxynitride waveguides etc. for integration of the Faraday rotator waveguide onto a silicon substrate. Further, the writing parameters may be varied during the writing process from one end of the waveguide to another such that the Faraday rotator waveguide may interface to different optical waveguides at either end, e.g. one being a singlemode optical fiber and the other a singlemode silica-on-silicon substrate forming part of a photonic integrated circuit.

The employable laser writing conditions are limited by the damage threshold of the BIG material. Moreover, lower speed and smaller track spacing increase the manufacturing time, which can impact mass production. Further, larger cladding dimensions can tend to lead to increased risk of cracks due to the accumulated stress. The inventors established that cladding thicknesses between 15 μm and 20 μm, depending on the other optical waveguide parameters, were sufficient to minimize the optical waveguide loss whilst avoiding damage. Conditions for low lost optical waveguides include laser pulses between 0.4 μJ and 0.6 μJ with horizontal scan speeds between 0.3 and 0.5 mm/s. Table 1 below lists parameters for spiral-helix laser writing employed within embodiments of the invention by the inventors for depressed cladding waveguides in bismuth-doped iron garnet. However, it would be evident to one of skill in the art that other waveguide designs, manufacturing parameters etc. other than those above and within Table 1 may be implemented. These values here being exemplary values from the experiments performed by the inventors.

TABLE 1
Parameters for Spiral-Helix Laser Writing Depressed
Cladding Waveguides in Bismuth-Doped Iron Garnet

| Parameter | Value | Limitation |
|---|---|---|
| Pulse energy | 0.4 μJ to 0.6 μJ | Damage |
| Scan speed | 0.3 to 0.5 mm/s | Motorized stages employed |
| Horizontal laser tracks | 0.5 μm | Larger spacing feasible while |
| spacing | | keeping high uniformity |
| Vertical laser tracks | 7 μm | |
| spacing | | |

As noted in Table 1 the scan speed was limited by the available motorized stages but could be changed by employing different stages within the laser writing system. The smallest radii of curvature achieved within formation of laser “inscribed” structures were less than 10 μm. At larger scan speeds, e.g. over 0.5 mm/s in the experiments performed by the inventors, it was observed that the waveguide did not remain perfectly circular.

It would be evident that whilst a spiral-helix writing process may employ a constant set of parameters, e.g. pulse energy, scan speed, horizontal track spacing, and vertical track spacing, that one or more of these parameters may also be varied during the spiral-helix writing process. In addition the actual dimensions of the written structure can be varied such that uniform and non-uniform optical waveguides can be written according to the requirements of the optical element being disposed within the photonic integrated circuit.

Using the parameters presented in Table 1 the inventors formed waveguides within BIG having inner cladding diameters ranging from 7 μm to 18 μm have been laser inscribed. Referring to FIG. 16 there is depicted the measured insertion loss for spiral-helix written waveguides within BIG butt coupled between two standard singlemode optical fibers at 1550 nm as the inner cladding diameter was varied from 7 μm to 18 μm. The BIG waveguide disposed between the pair of standard singlemode optical fibers is depicted in FIG. 17.

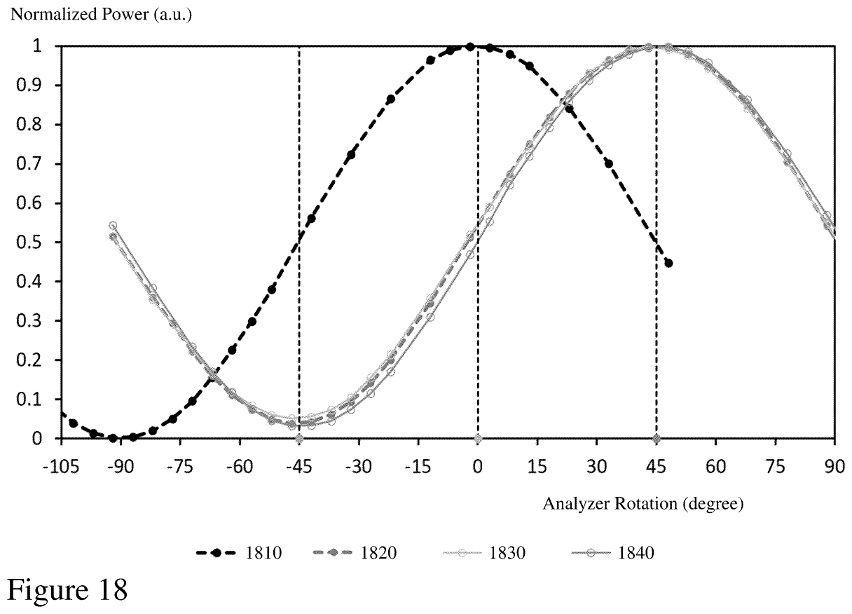

Referring to FIG. 18 there are depicted normalized plots of transmission, between a pair of orthogonal polarizers, for optical fiber, bulk BIG and two BIG waveguides as fabricated according to embodiments of the invention. Accordingly, the bulk 480 μm thick BIG (second Curve 1820) exhibits a 45° rotation relative to the optical fiber (first Curve 1810) whilst the two samples with optical waveguides laser written within the BIG, third and fourth Curves 1830 and 1840 respectively) similarly exhibited a 45° rotation showing that the laser wiring process whilst forming the optical waveguide within the BIG had not reduced its magneto-optic properties.

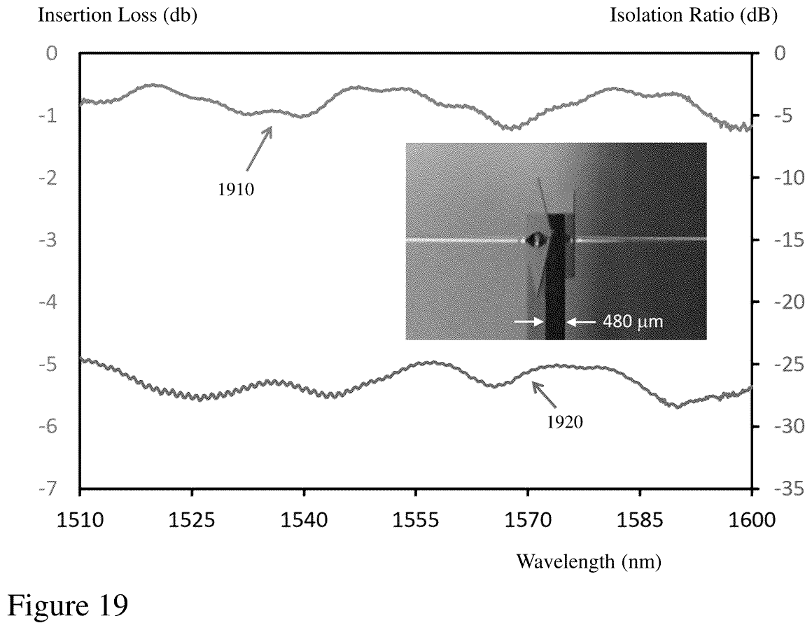

Accordingly, the performance of 480 μm long BIG waveguide disposed between a pair of orthogonally orientated polarizer sheets and standard singlemode optical fibers was evaluated. The results of this together with a photograph of the assembly are depicted within FIG. 19. The insertion loss (first Curve 1910) ranged from a minimum of ˜0.5 dB to a maximum of ˜1.2 dB with an average insertion loss over the range 1510 nm to 1600 nm of 0.81 dB. Over the same range the isolation (second Curve 1920) ranged from a minimum of ˜24.5 dB to a maximum of ˜28.5 dB with an average isolation of 26.5 dB.

Whilst the 480 μm optical waveguide was formed within a 480 μm thick sheet of BIG 11 mm×11 mm it would be evident that the principle can be applied to BIG sheets of different dimensions such that the magnetless Faraday rotator is directly formed within a small block of material and directly placed within a photonic integrated circuit such as described above or that an array of waveguides are formed within a larger sheet, separated and then placed within the photonic integrated circuit.

It would be further evident that the spiral-helix writing methodology described above may be applied to the formation of other waveguides. In some embodiments of the spiral-helix writing the index change induced is an increase such that the core of the waveguide is written whilst within others, such as the BIG embodiment described above, the index change induced is a decrease such that the cladding of the waveguide is written.

Whilst within the embodiments described above laser induced refractive index changes have been described and presented with respect to BIG it would be evident to one of skill in the art that within other embodiments of the invention other irradiation means to induce a refractive index change in the material may be employed.

Whilst within the embodiments of the invention the embodiments have been presented with a bismuth-doped iron garnet sheet or film with uniform doping it would be evident that within other embodiments of the invention a spatial variation of a dopant or dopants may be established prior to irradiation such that the refractive index adjustment is a combination of irradiation and dopant density.

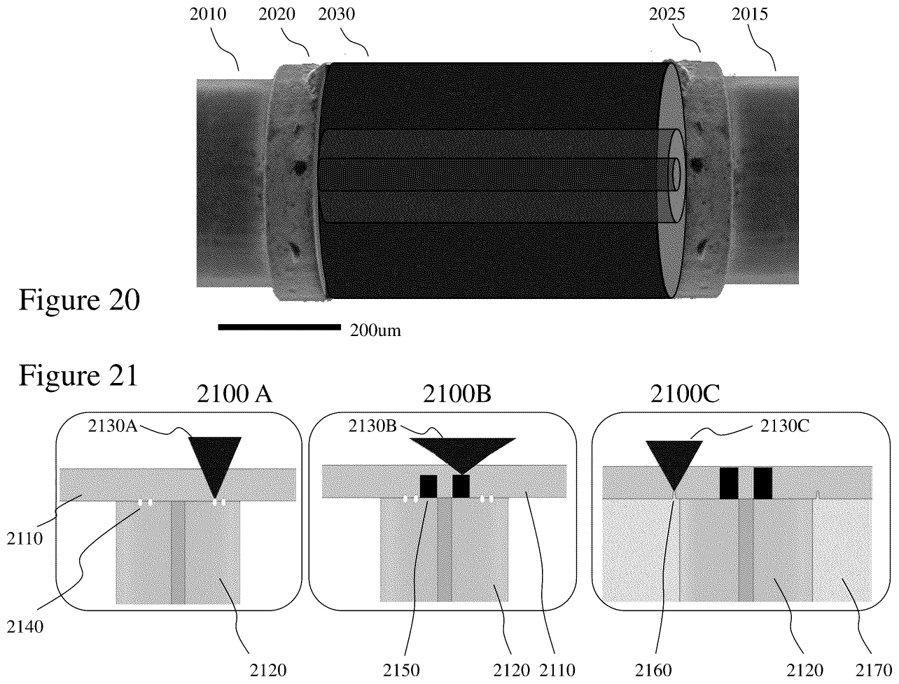

The inventors have established optical fiber assemblies to assemble with magnetless Faraday rotator elements fabricated using the techniques described and depicted in FIGS. 12A to 17 respectively. Within FIGS. 20 to 24 respectively these optical fiber assemblies are described and depicted with respect to the implementation of a magnetless waveguide Faraday rotator. However, it would be evident that provisioning of polarizer elements, such as described in respect of FIG. 19, would allow the techniques described and assemblies to be employed in forming magnetless optical waveguide isolators or that these elements may be employed within optical circulator implementations.

Referring initially to FIG. 20 there is depicted a schematic of a laser welded magnetless waveguide isolator according to an embodiment of the invention. Accordingly, a magnetless Faraday rotator (MFR) 2030 is depicted in the center. On the left hand side is a first optical sub-assembly (OSA) comprising an optical fiber 2010 and first glass plate (GP) 2020 whilst disposed on the right hand side is a second OSA comprising another optical fiber 2015 and second GP 2025. Accordingly, the assembly provides a magnetless optical waveguide Faraday rotator. Provisioning orthogonal polarizer elements between the first OSA and MFR 2030 and second OSA and MGR 2030 respectively, such as described in FIG. 19, would provide for a magnetless laser welded optical waveguide isolator. Alternatively, by appropriate tooling and rotational alignment the first GP 2020 and second GP 2025 may be these orthogonal polarizer elements, e.g. Polarcor™ UltraThin™ polarizer sheet.

Now referring to FIG. 21 there are depicted first to third laser processing (LP) steps 2100A to 2100C for forming an optical fiber assembly, such as first OSA or second OSA in FIG. 20, for a laser welded magnetless waveguide Faraday rotator/isolator according to the design depicted in FIG. 20. In first LP step 2100A a laser 2130A is employed to weld (Weld 2140) a GP 2110 onto the end of an optical fiber (OF) 2120. This being, for example, a series of circular welds or other weld pattern. In second LP step 2100B a second laser 2130B is employed to write a depressed cladding 2150 within the GP 2110. In third LP step 2100C a third laser 2130C is employed to implement a cut 2160 to remove the GP 2110 around the OF 2120 from the overall sheet thereby generating a discrete laser welded OSA. Within embodiments of the invention the three lasers, namely first laser 2130A, second laser 2130B and third laser 2130C, may be three different lasers, two lasers with one laser for two of the first laser 2130A, second laser 2130B and third laser 2130C, or a single laser used for all three of first laser 2130A, second laser 2130B and third laser 2130C. Where a laser is used to two or three of the first laser 2130A, second laser 2130B and third laser 2130C then its optical characteristics may be different for the different laser steps. For example, if the laser is tunable then the emitting wavelength and power may both be varied whilst within another embodiment the laser may simply vary in output power.

Within other embodiments of the invention depending upon the properties of the GP 2110 a core may be written rather than a depressed cladding. Optionally, if the GP 2110 is sufficiently thin there may be no requirement to form either a core and/or depressed cladding within the GP 2110. Optionally, within third LP step 2100C

Referring to FIGS. 22 and 23 there are depicted photographs of an optical fiber assembly for a laser welded magnetless waveguide Faraday rotator/isolator according to the design depicted in FIG. 20. FIG. 22 depicts an end-on view of the GP 2110 wherein the OF 2120 and Weld 2140 are visible. FIG. 23 depicts an OSA comprising GP 2110 and OF 2120 are processing through all three LP steps such that the GP 2110 is laser welded to the OF 2120.

It would be evident that, referring to FIG. 20, the first GP 2020 and second GP 2025 may be welded to the MFR 2030 by projecting a laser through a GP, e.g. first GP 2020 or second GP 2025, or through the MFR 2030 to the interface between the GP and MFR 2030 to weld the pieces together or alternatively, the weld may be formed around the periphery of the joint between the GP and MFR 2030. Alternatively, the OSAs and MFR 2030 may be soldered together.

Now referring to FIG. 24 there is depicted the impact of fiber polishing on an optical fiber assembly for a laser welded magnetless waveguide Faraday rotator/isolator according to the design depicted in FIG. 20. In first Image 2400A the optical contact between an optical fiber and GP is depicted wherein interference fringes are evident due to the optical fiber not being in uniform contact with the GP. The optical fiber, for example, being cleaved as known in the art. However, second Image 2400B depicts the contact between a laser polished optical fiber and GP is depicted wherein no fringes are now visible indicating good uniform optical contact free of Fresnel reflections.

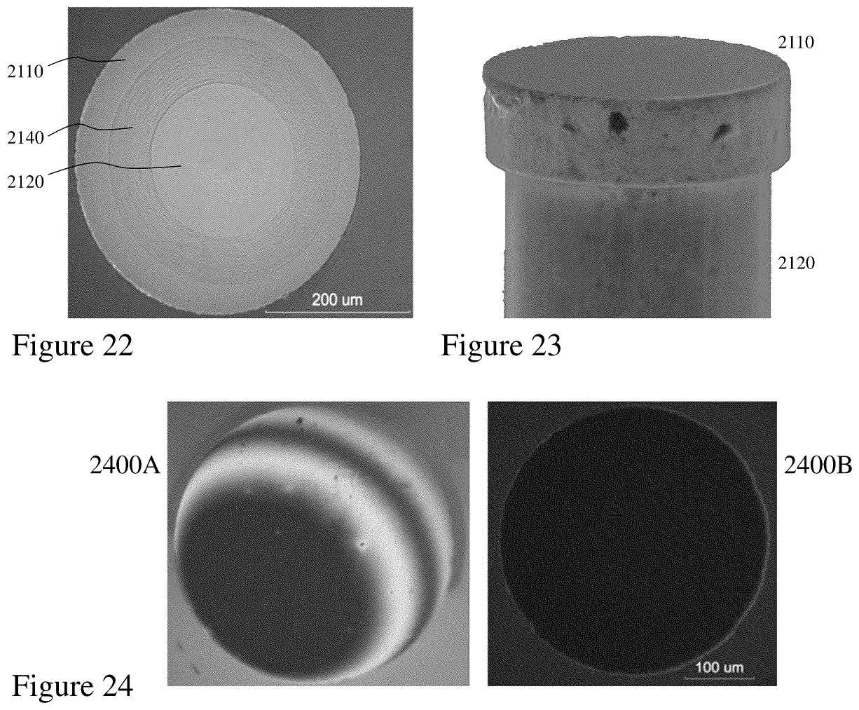

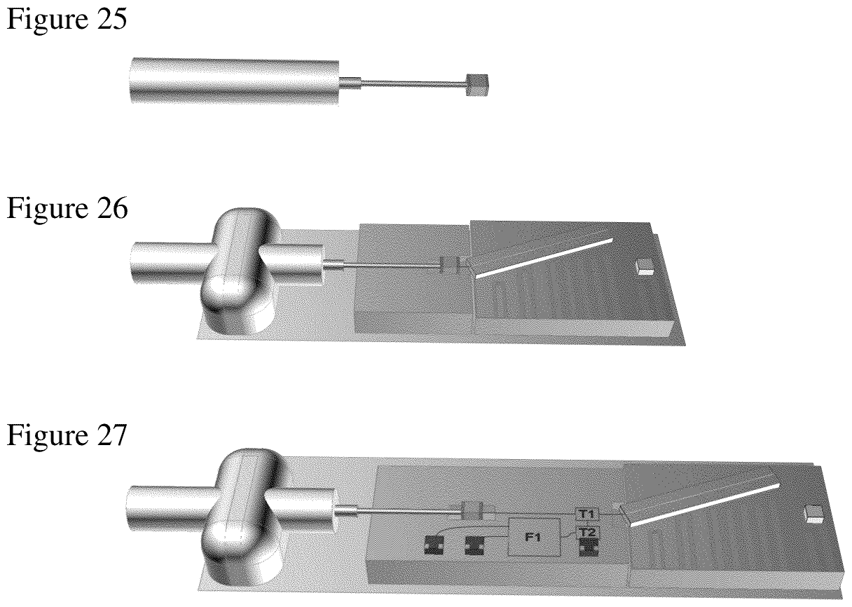

FIG. 25 depicts an optical fiber sub-assembly with a laser welded magnetless waveguide Faraday isolator attached at the end of the optical fiber according to an embodiment of the invention. The optical fiber sub-assembly depicted in FIG. 25 comprises an integrated optical isolator such as one exploiting the magnetless waveguide Faraday rotator described above laser welded to the end of an optical fiber. The magnetless waveguide Faraday rotator based isolator (hereinafter isolator or optical isolator) contains an optical waveguide structure, which is singlemode, matched to the optical fiber mode field diameter. The optical waveguide is inscribed using the disclosed laser processing techniques, e.g. femtosecond laser processing. The optical isolator may, for example, comprises a single waveguide core or multiple waveguide cores to match the optical fiber ode geometry.

The isolator may be polarization dependent, such as when employed in conjunction with a laser diode, such as in FIGS. 26 and 27 and may comprise, according to embodiments of the invention, a series of elements or “plates” as referred to by the inventors which may, for example, be:
polarizer (P)/garnet (G)/polarizer (P) (PGP);
polarizer/garnet/polarizer/rotator (PGPH) where H is a waveplate to rotate the polarization and is attached to the optical fiber;
a double isolator such as PGPGP; and
a double isolator with waveplate, e.g. PGPGPH.

Alternatively, the isolator can be polarization independent, such designs not being depicted but would be evident to one of skill in the art based upon the disclosure within this specification, for use within an optical amplifier for example. These may comprise, according to embodiments of the invention, a series of elements or “plates” which may, for example, be:
wedge (W)/garnet (G)/wedge (W) (GW) where a wedge is a birefringent crystal wedge (for example single crystal calcite or lithium niobate) as known in the art; and
dual stage WGWGW.

The optical fiber may, for example be, singlemode fiber (SMF), polarisation maintaining fiber (PMF), reduced cladding SMF or PMF, or a multi-core single mode fiber. The multiple plates of the isolator can be bonded together and may be cut to the required size using a laser assisted dicing technique (such as described above) or other suitable techniques. The optical fiber is precision aligned with the optical isolator's internal optical waveguide and then bonded using laser-assisted fusion or other suitable technique(s). Optionally, the isolator is marked with registration or alignment marks for proper orientation during subsequent assembly with other optical elements. The isolator sidewalls may be employed as “diced” or after further processing, e.g. polishing.

Now referring to FIG. 26 there is depicted an optical fiber sub-assembly with a laser welded magnetless waveguide Faraday isolator attached at the end of the optical fiber according to the design depicted in FIG. 25 assembled with a semiconductor laser diode. An isolator fiber assembly, such as depicted in FIG. 25, can be packaged into a silicon carrier (also referred to as a Si PIC die or micro-machined silicon block) designed, for example, such that the unclad (bare) optical fiber is within a U-groove or V-groove matching the diameter of the optical fiber to retain and support it. A cavity is formed within the silicon block which is deep enough and wide enough to accept the optical isolator. The U- or V-groove allows for an adhesive, dispensed or “wicked” along to bond the optical fiber to the Si PIC. The cavity also allows an adhesive to be employed to bond the optical isolator to the silicon block. The free end of the isolator may be connected optically to a laser facet by a photonic wire bond (PWB), micro-lens or another optical waveguide.

For a multicore fiber assembly with laser welded magnetless waveguide Faraday isolators attached at the end of the optical fiber, e.g. an optical fiber containing multiple single-mode waveguide cores assembled with the plates of an isolator incorporating an array of waveguide cores, multiple PWBs connecting the array of isolators and a multiplicity of laser sources/transmitters or PIC interfaces may be employed. A PWB machine vision system can identify the isolator waveguide core in a similar manner as the core of a single mode optical fiber for example.

Referring to FIG. 27 there is depicted an optical fiber sub-assembly with a laser welded magnetless waveguide Faraday isolator attached at the end of the optical fiber according to the design depicted in FIG. 25 assembled with a wavelength locker photonic integrated circuit and semiconductor laser diode. Accordingly, the optical assembly provides a laser diode optical emitter (transmitter) assembly with power monitoring, wavelength referencing and wavelength locking with modulation either through drive current to the laser or an external modulator integrated with the semiconductor laser diode or disposed between the isolator and semiconductor laser diode. The isolator fiber assembly can be packaged into a Si PIC die designed in a similar manner to that described within FIG. 26. In this instance the free end of the isolator can be connected optically to a PIC waveguide facet by a PWB, micro-lens, direct coupling etc. The silicon block as depicted also includes optical power taps (T1, T2) and integrated filter (F1, tunable or fixed) for wavelength referencing (locking). Photodiodes are also provided but not identified explicitly. In other embodiments of the invention (not depicted for clarity), the wavelength locker may be mounted at the back of the laser and the isolator mounted in a similar manner to that described within FIG. 26.

In the same manner as with FIG. 26 a multicore fiber assembly can be coupled via multiple PWBs to connect the fiber cores/isolator cores to a multiplicity of wavelength locker/power monitoring circuits within the silicon block and thereby to an array of laser diode emitters. Similarly, the PWB machine vision system can detect the isolator waveguide position, for example by side vision and/or top vision of the isolator waveguide through as-diced or polished sidewall of the garnet crystal.

Within another embodiment of the invention an isolator fiber assembly can be packaged into a Si PIC die such as described above in respect of FIG. 26. The free end of the isolator within this embodiment is sitting directly in front of a Si PIC waveguide of appropriate mode field diameter (MFD). Typically a MFD of about 10 μm at 1550 nm is obtained using adiabatic tapers, suspended waveguide structures etc. Accordingly, in this embodiment, the lateral-vertical (YZ) alignment is given by referencing the U-groove width and depth to the optical fiber of the isolator fiber assembly. The isolator fiber assembly is then butted to the Si PIC facet and an optical adhesive of suitable index of refraction is employed to reduce reflection and insertion loss.

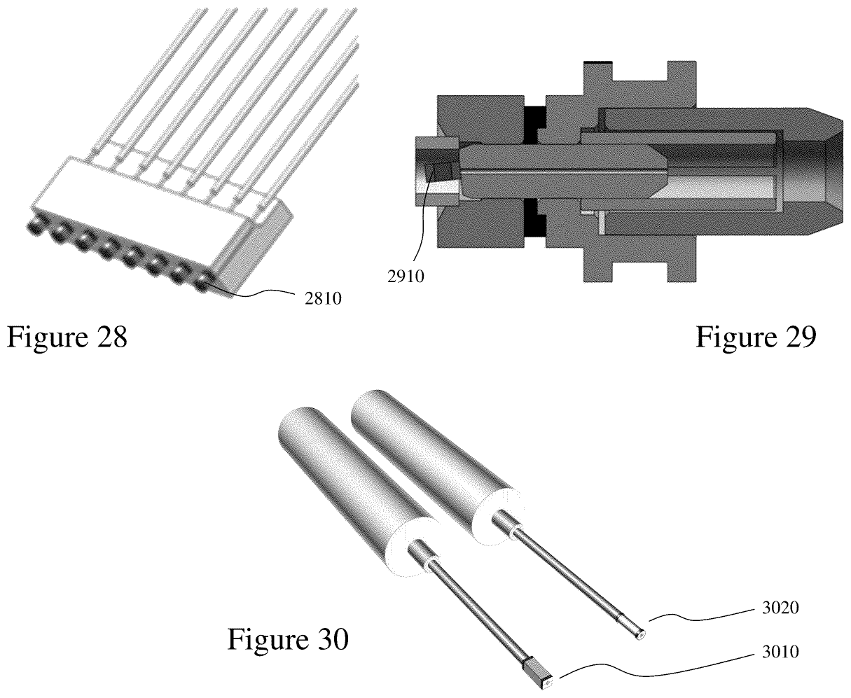

It would be evident to one of skill in the art that due to the nature of the isolator design depicted in FIG. 25 according to embodiments of the invention exploiting one or more garnet waveguides that this technology form an enabling building block for the miniaturization and cost reduction of the integration of optical isolator in optical sub-assemblies, especially for optical amplifiers, laser sources, optical transmitters etc. For example, referring to FIG. 28 there is depicted an array of laser welded magnetless waveguide Faraday isolators 2810 attached at the ends of optical fibers assembled within a silicon V-groove assembly according to an embodiment of the invention. Alternatively, as depicted in FIG. 29, a laser welded magnetless waveguide Faraday isolator 2910 may be integrated within an optical fiber connector according to an embodiment of the invention.

It would be evident that, as depicted in FIG. 30, the laser welded magnetless waveguide Faraday isolators may be dimensioned such that they are similar to or equal to the diameter of the optical fiber. As depicted in FIG. 30 optical fiber sub-assemblies with laser welded magnetless waveguide Faraday isolators are depicted. These may have a square profile (first laser welded magnetless waveguide Faraday isolator 3010) or circular profile (second laser welded magnetless waveguide Faraday isolator 3020) for example. The laser welded magnetless waveguide Faraday isolators may be as described above in respect of FIG. 25.

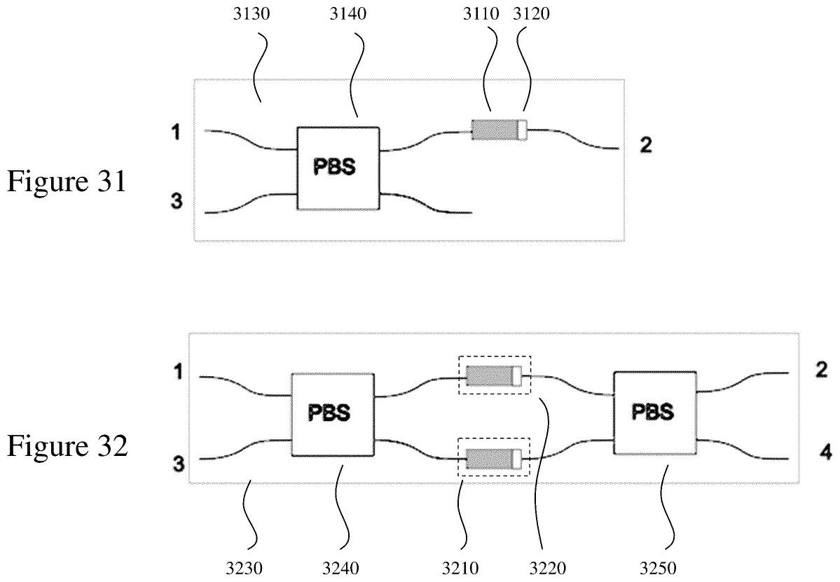

It would also be evident that the laser welded magnetless waveguide Faraday isolators may be employed within polarisation insensitive optical isolator (FIG. 31) and optical circulator designs (FIG. 32). The optical fiber coupled laser welded magnetless waveguide Faraday rotator may, for example, be according to the design depicted in FIG. 20 or optical fiber coupled laser welded magnetless waveguide Faraday rotator as depicted in FIG. 25 for example.

Referring to FIG. 31 a polarisation dependent optical isolator design is depicted. As shown a magnetless waveguide Faraday based isolator, using a latched garnet waveguide (GW) 3110 and a half wave plate (HWP) 3120 bonded together, is depicted inserted into a cavity of a Si PIC die 3130. A polarization beam splitter (PBS) 3140 circuits is also implemented on the Si PIC die 3130.

Referring to FIG. 32 a polarization independent optical isolator/circulator design is depicted. A pair of magnetless waveguide Faraday based isolators, first isolator 3210 and second isolator 3220, are depicted each employing a latched garnet waveguide (GW) and half wave plate (HWP) bonded together. These are placed within cavities of a Si PIC die 3230 employing optical waveguides that couple to/from first and second polarization beam splitter (PBS) circuits 3240 and 3250 integrated within the Si PIC. 3230 as well as to/from external circuitry.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Values of design parameters, material parameters, performance parameters, processing parameters etc. within the specification relate to initial experiments, devices, etc. undertaken by the inventors. The scope of the invention is not defined by these as other values of design parameters, material parameters, performance parameters, processing parameters etc. may be employed without departing from the scope of the invention.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

1. A method of forming an optical waveguide within a material comprising:
establishing a spatial profile for a focal region of an irradiating source through a volume of a material from a first side of the material to a second distal side of the material; and
executing a motion sequence such that the focal region the irradiating source traverses the spatial profile within the volume of the material; wherein
the optical waveguide is formed through the volume of the material from the first side of the material to the second distal side of the material.

2. The method according to claim 1, wherein
the spatial profile comprises:
a bottom horizontal portion executed with an initial spiral sequence forming part of the motion sequence at the first side of the material; and
an ascending vertical portion executed with a helical sequence forming another part of the motion sequence to traverse from the first side of the material to the second side of the material.

3. The method according to claim 1, wherein
the focal region of the irradiating source results in a reduction in refractive index such that the spatial profile relates to a cladding of the optical waveguide;
the spatial profile comprises:
a bottom horizontal portion executed with an initial spiral sequence forming part of the motion sequence at the first side of the material; and
an ascending vertical portion executed with a helical sequence forming another part of the motion sequence to traverse from the first side of the material to the second side of the material;
the helical sequence employs a helix which alternates inside and outside of another volume of the material; and
the another volume forms the cladding such that the entire optical waveguide can be generated in a single scan.

4. The method according to claim 1, wherein
the material is bismuth-doped iron garnet;
the optical waveguide is formed along a predetermined axis of the bismuth-doped iron garnet such that the optical waveguide provides magnetless Faraday rotation of optical signals propagating through the optical waveguide; and
a thickness of the material from the first side of the material to the second side of the material defines a magnitude of a polarization rotation to the optical signals propagating in one direction with the optical waveguide.

5. The method according to claim 1, wherein
the focal region of the irradiating source results in a reduction in refractive index such that the spatial profile relates to a cladding of the optical waveguide;
the spatial profile comprises:
a bottom horizontal portion executed with an initial spiral sequence forming part of the motion sequence at the first side of the material; and
an ascending vertical portion executed with a helical sequence forming another part of the motion sequence to traverse from the first side of the material to the second side of the material;
the helical sequence employs a helix which alternates inside and outside of another volume of the material;
the another volume forms the cladding such that the entire optical waveguide can be generated in a single scan;
the material is bismuth-doped iron garnet;
the optical waveguide is formed along a predetermined axis of the bismuth-doped iron garnet such that the optical waveguide provides magnetless Faraday of rotation of optical signals propagating the through the optical waveguide; and
a thickness of the material from the first side of the material to the second side of the material defines a magnitude of a polarization rotation to the optical signals propagating in one direction with the optical waveguide.

6-7. (canceled)

8. A method comprising:
providing an optical component;
providing a photonic integrated circuit (PIC) comprising:
an input waveguide coupled to a first end of the optical component for at least one of coupling optical signals to or receiving optical signals from the optical component;
an output waveguide coupled to a second distal end of the optical component for at least one of coupling optical signals to or receiving optical signals from the optical component;
assembling the optical component upon a first carrier; and
assembling the PIC upon a second carrier; wherein
the first carrier is either a substrate of the PIC or an intermediate carrier between the optical component and the second carrier;
a first portion of the optical component provides a passive optical function;
a second portion of the optical component provides an active optical function; and
the optical component is at least one of a thin film structure or a bulk structure.

9. The method according to claim 8, wherein
a portion of the optical component is directly written into a material of the optical component prior to assembling the first component upon the first carrier.

10. The method according to claim 8, wherein
a portion of the optical component is directly written into a material of the optical component after assembling the first component upon the first carrier.

11. The method according to claim 8, wherein
a first portion of the optical component is directly written into a material of the optical component prior to assembling the first component upon the first carrier; and
a second portion of the optical component is directly written into a material of the optical component after assembling the first component upon the first carrier.

12. The method according to claim 8, further comprising:
forming a first photonic wire bond (PWB) disposed between the optical component and the input waveguide; and
forming a second PWB disposed between the optical component and the output waveguide.

13. The method according to claim 12, wherein
a portion of the optical component is directly written into a material of the optical component prior to assembling the first component upon the first carrier.

14. The method according to claim 12, wherein
a portion of the optical component is directly written into a material of the optical component after assembling the first component upon the first carrier.

15. The method according to claim 12, wherein
a first portion of the optical component is directly written into a material of the optical component prior to assembling the first component upon the first carrier; and
a second portion of the optical component is directly written into a material of the optical component after assembling the first component upon the first carrier.

16. A method comprising:
providing an optical component;
providing a photonic integrated circuit (PIC) comprising an input waveguide coupled to a first end of the optical component for at least one of coupling optical signals to or receiving optical signals from the optical component;
assembling the optical component upon a first carrier;
assembling the PIC upon a second carrier;
forming a first photonic wire bond (PWB) disposed between the optical component and the input waveguide;
the first carrier is either a substrate of the PIC or an intermediate carrier between the optical component and the second carrier; wherein
a first portion of the optical component provides a passive optical function;
a second portion of the optical component provides an active optical function; and
the optical component is at least one of a thin film structure or a bulk structure.

17. The method according to claim 16, wherein
a portion of the optical component is directly written into a material of the optical component prior to assembling the first component upon the first carrier.

18. The method according to claim 16, wherein
a portion of the optical component is directly written into a material of the optical component after assembling the first component upon the first carrier.

19. The method according to claim 16, wherein
a first portion of the optical component is directly written into a material of the optical component prior to assembling the first component upon the first carrier; and
a second portion of the optical component is directly written into a material of the optical component after assembling the first component upon the first carrier.

20. The method according to claim 16, wherein
the first PWB is formed by direct writing of a waveguide core of the first PWB within one or more materials disposed within a first pool;
a first sidewall of the first pool is formed within the second carrier;
a second sidewall of the first pool is formed within the second carrier opposite the first sidewall;
a third sidewall of the first pool is formed within the second carrier and extends between the first sidewall and the second sidewall proximate the input optical waveguide;
a first portion of a fourth sidewall of the first pool is formed by a portion of the first carrier;
a second portion of the fourth sidewall of the first pool is formed by a portion of the first end of the optical component.

21. The method according to claim 16, further comprising
providing an output waveguide as part of the PIC coupled to a second distal end of the optical component for at least one of coupling optical signals to or receiving optical signals from the optical component; and
forming a second PWB disposed between the optical component and the output waveguide; wherein
the second PWB is formed by direct writing a waveguide core of the second PWB within one or more materials disposed within a second pool;
a first sidewall of the second pool is formed within the second carrier;
a second sidewall of the second pool is formed within the second carrier opposite the first sidewall;
a third sidewall of the second pool is formed within the second carrier and extends between the first sidewall and the second sidewall proximate the output optical waveguide;
a first portion of a fourth sidewall of the second pool is formed by a portion of the first carrier;
a second portion of the fourth sidewall of the second pool is formed by a portion of the second end of the optical component.
